(19) United States
(12) Patent Application Publication
(10) Pub. No.: US 2025/0370614 A1
(43) Pub. Date: Dec. 4, 2025

(54) APPARATUS, DISPLAY SYSTEM, GESTURE RECOGNITION METHOD, AND NON-TRANSITORY RECORDING MEDIUM

(71) Applicants: Keiichi Yokota, KANAGAWA (JP); Susumu Fujioka, KANAGAWA (JP)

(72) Inventors: Keiichi Yokota, KANAGAWA (JP); Susumu Fujioka, KANAGAWA (JP)

(73) Assignee: Ricoh Company, Ltd., Tokyo (JP)

(21) Appl. No.: 19/190,043

(22) Filed: Apr. 25, 2025

(30) Foreign Application Priority Data
May 28, 2024 (JP) 2024-086208

(51) Int. Cl. G06F 3/04883; G06F 3/0354; G06V 40/30

(52) U.S. Cl. CPC G06F 3/04883; G06F 3/03545; G06V 40/376

(57) ABSTRACT

An apparatus includes circuitry. The circuitry acquires information related to a shape of a pointing object from a sensor that acquires the information. The circuitry recognizes a gesture operation based on the acquired information. The gesture operation corresponds to a motion of the pointing object, and is recognizable in one of at least three layers in which a plurality of gesture operations are classified. When the circuitry recognizes a first gesture operation in a top layer of the at least three layers, the circuitry becomes ready to recognize a gesture operation classified in a second layer of the at least three layers. When the circuitry recognizes a second gesture operation in the second layer, the circuitry becomes ready to recognize a gesture operation classified in a third layer of the at least three layers.

### CROSS-REFERENCE TO RELATED APPLICATIONS

This patent application is based on and claims priority pursuant to 35 U.S.C. § 119(a) to Japanese Patent Application No. 2024-086208, filed on May 28, 2024, in the Japan Patent Office, the entire disclosure of which is hereby incorporated by reference herein.

### BACKGROUND

### Technical Field

The present disclosure relates to an apparatus, a display system, a gesture recognition method, and a non-transitory recording medium.

### Related Art

There are many apparatuses that receive operations via a touch panel. These operations include gesture operations, which are widely used as a means for a user to efficiently operate an apparatus.

There is a technique of smoothly processing operations performed by a user including the gesture operations. For example, there is an apparatus that, in response to a particular gesture performed by a user, activates a driver for a world wide web (web) camera to receive touch or gesture input.

### SUMMARY

The present disclosure described herein provides an apparatus that includes, for example, circuitry that acquires information related to a shape of a pointing object from a sensor that acquires the information. The circuitry further recognizes a gesture operation based on the acquired information. The gesture operation corresponds to a motion of the pointing object, and is recognizable in one of at least three layers in which a plurality of gesture operations are classified. When the circuitry recognizes a first gesture operation in a top layer of the at least three layers, the circuitry becomes ready to recognize a gesture operation classified in a second layer of the at least three layers. When the circuitry recognizes a second gesture operation in the second layer, the circuitry becomes ready to recognize a gesture operation classified in a third layer of the at least three layers.

The present disclosure described herein further provides a display system that includes, for example, an apparatus and an information processing system. The apparatus recognizes a gesture operation corresponding to a motion of a pointing object, and receives an operation according to the gesture operation. The information processing system communicates with the apparatus via a network. The apparatus includes first circuitry and a first network interface circuit. The first circuitry acquires information related to a shape of the pointing object from a sensor that acquires the information. The first network interface circuit transmits the information to the information processing system. The information processing system includes second circuitry and a second network interface circuit. The second circuitry analyzes the information received from the apparatus, and recognizes the gesture operation based on the information acquired by the sensor. The gesture operation is recognizable in one of at least three layers in which a plurality of gesture operations are classified. The second network interface circuit reports to the apparatus a layer of the at least three layers corresponding to the recognized gesture operation. When the second circuitry of the information processing system recognizes a first gesture operation in a top layer of the at least three layers, the second circuitry of the information processing system becomes ready to recognize a gesture operation classified in a second layer of the at least three layers. When the second circuitry of the information processing system recognizes a second gesture operation in the second layer, the second circuitry of the information processing system becomes ready to recognize a gesture operation classified in a third layer of the at least three layers. The first circuitry of the apparatus executes a process in the layer reported from the information processing system.

The present disclosure described herein further provides a gesture recognition method that includes, for example, acquiring information related to a shape of a pointing object from a sensor, and recognizing a gesture operation based on the acquired information. The gesture operation corresponds to a motion of the pointing object, and is recognizable in one of at least three layers in which a plurality of gesture operations are classified. When the recognizing recognizes a first gesture operation in a top layer of the at least three layers, the method further includes becoming ready to recognize a gesture operation classified in a second layer of the at least three layers. When the recognizing recognizes a second gesture operation in the second layer, the method further includes becoming ready to recognize a gesture operation classified in a third layer of the at least three layers.

The present disclosure described herein further provides a non-transitory recording medium storing a plurality of instructions which, when executed by one or more processors, causes the one or more processors to perform the above-described gesture recognition method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of layered gesture operations according to a first embodiment of the present disclosure;

FIG. 2 is a diagram illustrating an example of a screen displayed by an apparatus according to the first embodiment;

FIG. 3 is a diagram illustrating an example of a use situation of the apparatus used in an actual meeting room;

FIG. 4 is a diagram illustrating exemplary general arrangement of a communication system according to the first embodiment;

FIG. 5 is a diagram illustrating an exemplary hardware configuration of the apparatus;

FIG. 6 is a functional block diagram illustrating exemplary functional blocks of the apparatus;

FIG. 7 is a table illustrating object data stored in an object data storing unit of the apparatus;

FIG. 8 is a diagram schematically illustrating a model according to the first embodiment that detects the state of a hand from range image data;

FIG. 9 is a diagram illustrating an exemplary configuration of a gesture recognition model according to the first embodiment;

FIG. 10 is a diagram illustrating an exemplary layout of a right finger image capturing camera and a left finger image capturing camera according to the first embodiment;

FIG. 11A is a diagram schematically illustrating a right captured image captured by the right finger image capturing camera;

FIG. 11B is a diagram schematically illustrating a left captured image captured by the left finger image capturing camera;

FIG. 12 is a front view of a display of the apparatus;

FIGS. 13A and 13B are diagrams illustrating a gesture operation for the apparatus to transition to a pointer mode;

FIG. 14 is a diagram illustrating a gesture operation of pointing the forefinger performed by a user in the pointer mode;

FIG. 15 is a diagram illustrating a gesture operation for ending the pointer mode performed by the user in the pointer mode;

FIG. 16 is a flowchart illustrating an exemplary process in which the user causes the apparatus to transition to the pointer mode with a gesture operation;

FIG. 17 is a flowchart illustrating an exemplary process in which the user ends the pointer mode with a gesture operation;

FIG. 18 is a diagram illustrating a gesture operation for the apparatus to transition to a pen mode;

FIG. 19 is a diagram illustrating a gesture operation for the apparatus to display a pen icon in the pen mode;

FIG. 20 is a diagram illustrating a gesture operation for the apparatus to draw a line in the pen mode;

FIG. 21 is a diagram illustrating a gesture operation for the apparatus to draw a line again in the pen mode;

FIGS. 22A and 22B (FIG. 22) are a flowchart illustrating an exemplary process in which the user causes the apparatus to transition to the pen mode and end the pen mode with gesture operations;

FIG. 23 is a diagram illustrating a writable/drawable area and menu buttons on the display;

FIG. 24 is a diagram illustrating an example of a selection menu displayed on the display;

FIG. 25 is a diagram illustrating a display example of menu buttons not used in the pen mode;

FIG. 26 is a flowchart illustrating an example of a method of operating menu buttons in the pen mode;

FIG. 27 is a diagram illustrating a gesture operation for the apparatus to transition to a marker mode;

FIG. 28 is a diagram illustrating a gesture operation for the apparatus to display a marker icon in the marker mode;

FIG. 29 is a diagram illustrating a gesture operation for the apparatus to draw a line in the marker mode;

FIG. 30 is a diagram illustrating a gesture operation for the apparatus to draw a line again in the marker mode;

FIG. 31 is a diagram illustrating a gesture operation for the apparatus to transition to an eraser mode;

FIG. 32 is a diagram illustrating a gesture operation for the apparatus to display an eraser icon in the eraser mode;

FIG. 33 is a diagram illustrating a gesture operation for the apparatus to erase a drawn line in the eraser mode;

FIGS. 34 and 35 are diagrams illustrating gesture operations for the apparatus to erase another drawn line in the eraser mode;

FIGS. 36A and 36B (FIG. 36) are a flowchart illustrating an exemplary process in which the user causes the apparatus to transition to the eraser mode and end the eraser mode with gesture operations;

FIG. 37 is a diagram illustrating a gesture operation for switching a page;

FIG. 38 is a flowchart illustrating an exemplary process in which the user switches the page with a gesture operation;

FIG. 39 is a diagram illustrating an example of layered gesture operations available in an apparatus according to a second embodiment of the present disclosure;

FIG. 40 is a functional block diagram illustrating exemplary functional blocks of the apparatus of the second embodiment;

FIG. 41 is a flowchart illustrating an exemplary process in which the user causes the apparatus of the second embodiment to transition to a voice recognition mode with a gesture operation;

FIG. 42 is a flowchart illustrating an exemplary process in which the user ends the voice recognition mode with a gesture operation;

FIG. 43 is a diagram illustrating a gesture operation for the apparatus of the second embodiment to display a pointer in a language selection mode;

FIGS. 44A and 44B (FIG. 44) are a flowchart illustrating an exemplary process in which the user causes the apparatus of the second embodiment to transition to the language selection mode and end the language selection mode with gesture operations;

FIG. 45 is a diagram illustrating a gesture operation for the apparatus of the second embodiment to display the pointer in an industry selection mode;

FIGS. 46A and 46B (FIG. 46) are a flowchart illustrating an exemplary process in which the user causes the apparatus of the second embodiment to transition to the industry selection mode and end the industry selection mode with gesture operations;

FIG. 47 is a diagram illustrating an exemplary system configuration of a display system according to a third embodiment of the present disclosure;

FIG. 48 is a diagram illustrating an exemplary hardware configuration of an information processing system included in the display system;

FIG. 49 is a functional block diagram illustrating exemplary functional blocks of the display system; and

FIG. 50 is a sequence diagram illustrating an exemplary process in which the information processing system and the apparatus of the third embodiment communicate with each other to perform gesture recognition and display coordinates pointed by the forefinger.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an apparatus and a gesture recognition method performed by the apparatus are described below as exemplary embodiments of the present disclosure. As used herein, the singular forms “a,” “an,” and “the” are intended to include the plural forms as well, unless the context clearly indicates otherwise.

A first embodiment of the present disclosure will be described.

In an apparatus according to the first embodiment, gesture operations are layered to receive more operations with less gesture operations. The gesture operations include a gesture operation for drawing a line, enabling a user to draw a line with the gesture operation.

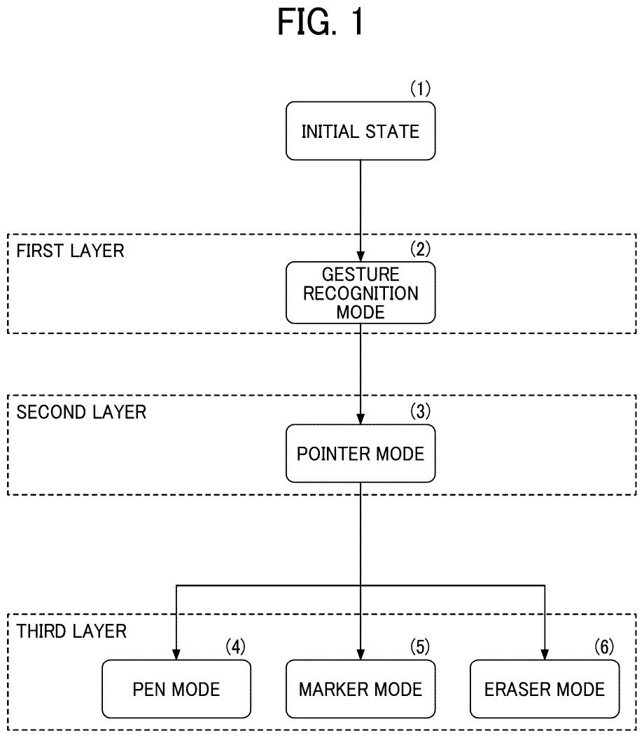

FIG. 1 is a diagram illustrating an example of the layered gesture operations.

The apparatus is brought into an initial state ((1) of FIG. 1) at power-on or return from a sleep mode. If the apparatus in the initial state recognizes a gesture operation of showing the palm of a hand, the apparatus transitions to a gesture recognition mode (an example of a top layer, i.e., a first layer). In the initial state, the recognition is limited to the palm of a hand to prevent the user from unknowingly causing the apparatus to transition to the gesture recognition mode.

The gesture recognition mode ((2) of FIG. 1) is a mode in which a gesture operation for transitioning to a pointer mode is recognizable. The gesture recognition mode corresponds to a state in which the apparatus receives the first gesture after being initialized. Therefore, the gesture recognition mode may also be called a gesture idle state. If the apparatus in the gesture recognition mode recognizes a gesture operation of swinging the palm of a hand upward, the apparatus transitions to the pointer mode (an example of a second layer).

The pointer mode ((3) of FIG. 1) is a mode in which coordinates pointed by the index finger (hereinafter occasionally referred to as the forefinger) are detected. In the pointer mode, therefore, the apparatus recognizes a gesture operation of pointing the forefinger, enabling the user to move a pointer or a mouse cursor. The pointer mode transitions to one of three other modes depending on the next gesture operation. In response to a gesture operation of swinging the palm of a hand downward, the pointer mode returns to the gesture recognition mode.

If the apparatus in the pointer mode recognizes a gesture operation of swinging two fingers horizontally, the apparatus transitions to a pen mode ((4) of FIG. 1). The pen mode (an example of a third layer) is a mode for the user to draw a line with the forefinger. If the user closes the forefinger (i.e., closes the hand), the pen mode ends to return to the gesture recognition mode. This gesture operation for ending the current mode similarly applies to a marker mode and an eraser mode (examples of the third layer) described below.

If the apparatus in the pointer mode recognizes a gesture operation of swinging three fingers horizontally (an example of a second gesture operation), the apparatus transitions to the marker mode ((5) of FIG. 1). The marker mode is a mode for the user to draw a marker line with the forefinger.

If the apparatus in the pointer mode recognizes a gesture operation of swinging three fingers vertically, the apparatus transitions to the eraser mode ((6) of FIG. 1). The eraser mode is a mode for the user to erase a drawn line with the forefinger.

In each of the pointer mode, the pen mode, the marker mode, and the eraser mode, a gesture operation of pointing the index finger, a gesture operation of stretching the thumb, a gesture operation of closing the thumb, and a gesture operation of swinging four fingers to the left or right are available.

As described above, the apparatus recognizes the gesture operations previously set in the three layers corresponding to the gesture recognition mode (2), the pointer mode (3), and the pen mode (4) to the eraser mode (6). With the layered gesture operations, more operations are performed with less gesture operations, obviating the need for the user to memorize many gesture operations. For example, drawing a pen line in the pen mode, drawing a marker line in the marker mode, and erasing a pen-drawn line in the eraser mode are all performed with the forefinger. If the gesture operations are not thus layered, the user is expected to learn three times more gesture operations.

In a typical apparatus, types of gesture operations correspond one-to-one to commands to the apparatus. Therefore, a curved line not assigned with a command, for example, is difficult to draw with a gesture operation. Further, when a user hand-draws a line on a display of the typical apparatus, the user walks up to the apparatus. The apparatus of the first embodiment, on the other hand, has the pen mode, which enables a user in a seated state to draw a red line, for example, on a certain part of what is displayed on the apparatus by performing gesture operations. Consequently, the user does not need to walk up to the apparatus to draw the line.

Tiering the gesture operations into four or more layers, for example, involves gesture operations corresponding to the respective layers, complicating the operations and impairing usability for the user. If the layers of gesture operations are reduced to two layers, a different gesture operation is set for each operation. In this case, the types of gesture operations increase with an increase in operations, also resulting in decreased usability for the user. With the gesture operations tiered into three layers, on the other hand, two gesture operations are combined and associated with a corresponding command operation. Consequently, the increase in the types of gesture operations is suppressed, improving usability for the user.

In the pen mode or the marker mode, transition to a pen-down mode or a pen-up mode may take place. In the eraser mode, transition may take place to a mode in which a virtual eraser is in contact with the display or a mode in which the virtual eraser is separate from the display. The user is thus able to cause the apparatus to transition to a subordinate mode within a mode. Therefore, layering the gesture operations is unlikely to complicate the operations.

Some terms used in the present disclosure will be described.

A pointing object is an object that performs a gesture operation recognizable by the apparatus. As well as a human hand, the pointing object may be a pointer stick, an artificial hand, an equivalent of the pointer stick or artificial hand, a humanoid robot, or a non-humanoid robot, for example.

Swinging the palm of a hand or one, two, three, or four fingers refers to a human motion that may also be described as moving or swiftly shaking the palm of a hand or one, two, three, or four fingers, for example.

Being layered is a state in which a plurality of layers are vertically connected. In the first embodiment, the modes of the apparatus have a layered structure, and recognizable gesture operations are determined in accordance with the layer or mode. Therefore, the gesture operations also have a layered structure, although an identical gesture operation may be recognized in different layers or modes. In the first embodiment, the three-layer structure will be described. However, the gesture operations or modes may have two layers or four or more layers.

One layer includes one or more modes. As well as transition between layers, transition to a subordinate mode within a mode may take place with a gesture operation. For example, each of the pen mode and the marker mode includes the pen-down mode and the pen-up mode. Further, the eraser mode includes the mode in which the virtual eraser is in contact with the display and the mode in which the virtual eraser is separate from the display.

A gesture refers to a type of body language expressed with a bodily motion using the body or a hand, for example. In the first embodiment, the user operates the apparatus with a gesture. Operating the apparatus with a gesture will be described as a gesture operation.

A first gesture operation refers to a gesture operation for transitioning from the top layer to the second layer. A second gesture operation refers to a gesture operation for transitioning from the second layer to the third layer.

An apparatus refers to an electronic apparatus that recognizes a gesture operation and receives an operation. The term “apparatus” may be used in contrast to an instrument or tool with a simple structure. In the first embodiment, an interactive whiteboard will be described as an example of the apparatus.

A use situation of the apparatus will be described.

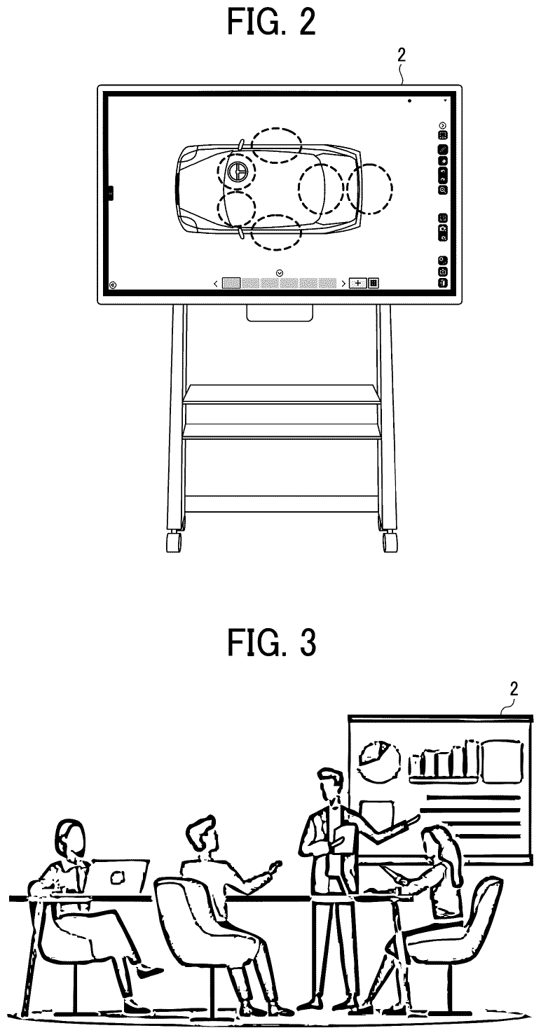

FIG. 2 illustrates an example of a screen displayed by an apparatus 2 according to the first embodiment. The apparatus 2 is an apparatus that causes a display, for example, to display in real time a character or shape drawn with a pen or finger via a touch panel. The user may set properties of a drawn line, such as the color and width of the drawn line, as desired. The apparatus 2 has a marker function to draw a line in a semi-transparent color. With the marker function, the apparatus 2 highlights a character or shape. The marker function is automatically disabled with the passage of a certain time. The apparatus 2 also has a function to perform character recognition on a drawn line and convert the drawn line into a character string or a shape. When connected to a personal computer (PC), for example, via a cable, the apparatus 2 may cause the display to display a screen displayed by the PC.

The apparatus 2 further has an eraser function to erase a drawn line, a character string, or a shape, for example. The apparatus 2 receives an operation of selecting a character string, for example, and moves or enlarges or reduces the selected character string as a group. The apparatus 2 handles a screen displayed on the display as one page and stores the screen as, for example, a one-page portable document format (PDF) file automatically or in accordance with a user operation. The apparatus 2 may alternatively handle an area larger than the size of the display as one screen. In this case, when the space for drawing or writing runs out, the user obtains a new space by sliding the screen, not by switching the page.

The apparatus 2 further has a function to connect to a network, which enables the apparatus 2 to communicate with another apparatus 2 at another location. The apparatuses 2 at the respective locations share the content of the screen. The apparatus 2 therefore enables a remote meeting between different locations as well as an in-person meeting in a meeting room. A general-purpose information processing apparatus may receive data of the screen from the apparatus 2 and display the screen. Thereby, a user is able to join the meeting from home, for example, without the apparatus 2.

FIG. 3 illustrates the apparatus 2 used in an actual meeting room. In FIG. 3, the apparatus 2 is placed in the meeting room with participants seated at a table in front of the apparatus 2. Enabling the participants to draw or write with gesture operations in the seated state makes the apparatus 2 versatile. For example, if one of the participants says “that part” while pointing at the apparatus 2, the other participants may not necessarily understand what is being pointed at. In this case, the participant typically walks up to the apparatus 2 to clarify the pointed position. The apparatus 2 of the first embodiment enables the participants to draw or write while being seated, reducing the need for the participants to walk up to the apparatus 2.

An exemplary system configuration of the first embodiment will be described.

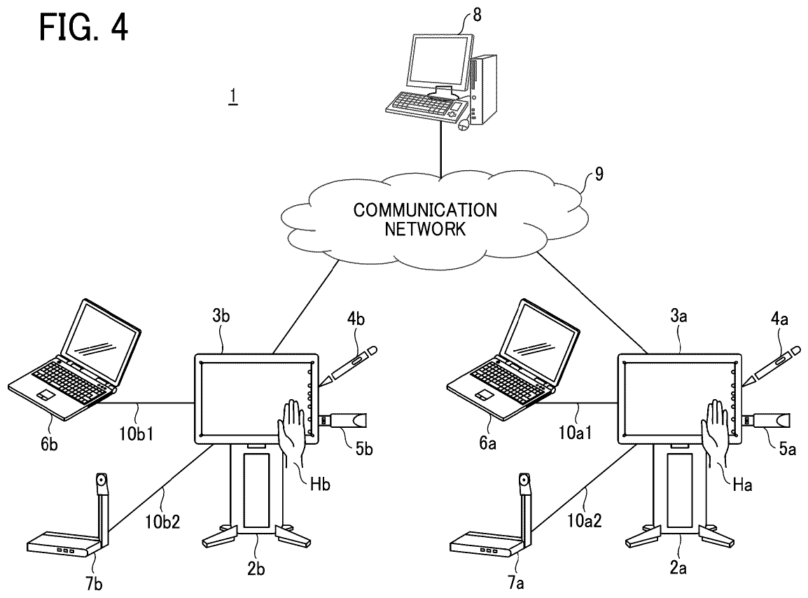

FIG. 4 is a diagram illustrating general arrangement of a communication system 1 according to the first embodiment. FIG. 4 illustrates two apparatuses 2a and 2b and accompanying electronic pens (styluses) 4a and 4b for the purpose of simplifying illustration. The communication system 1 may include three or more apparatuses 2 and three or more electronic pens 4.

As illustrated in FIG. 4, the communication system 1 includes the apparatuses 2a and 2b, the electronic pens 4a and 4b, universal serial bus (USB) memories 5a and 5b, laptop PCs 6a and 6b, teleconference (videoconference) terminals 7a and 7b (hereinafter simply referred to as the teleconference terminals 7a and 7b), and a PC 8. The apparatuses 2a and 2b and the PC 8 are communicably connected to each other via a communication network 9. The apparatuses 2a and 2b are equipped with displays 3a and 3b, respectively.

The apparatus 2a causes the display 3a to display an image rendered based on an event caused by the electronic pen 4a (e.g., a touch on the display 3a by the head or end of the electronic pen 4a). The apparatus 2a also changes the image displayed on the display 3a based on an event caused by the electronic pen 4a or a hand H a of a user, for example (e.g., a gesture operation for enlarging or reducing the image or switching the page).

The USB memory 5a is connectable to the apparatus 2a. The apparatus 2a reads an electronic file such as a PD F file from the USB memory 5a, or records an electronic file on the USB memory 5a. The apparatus 2a includes interfaces conforming to standards such as DisplayPort™, digital visual interface (DVI), high-definition multimedia interface (HDMI®), and video graphics array (VGA®). The user connects the apparatus 2a to the laptop PC 6a via a cable 10a1 conforming to a corresponding one of the above-described standards.

In response to a touch on the display 3a, the apparatus 2a causes an event and transmits event information indicating the event to the laptop PC 6a similarly as in an event from an input device such as a mouse or a keyboard. The apparatus 2a is also connected to the teleconference terminal 7a via a cable 10a2 that enables communication according to a corresponding one of the above-described standards. The laptop PC 6a and the teleconference terminal 7a may communicate with the apparatus 2a via wireless communication conforming to a wireless communication protocol such as Bluetooth®.

At the other location where the apparatus 2b is placed, the apparatus 2b equipped with the display 3b, the electronic pen 4b, the USB memory 5b, the laptop PC 6b, the teleconference terminal 7b, and cables 10b1 and 10b2 are used similarly as described above. The apparatus 2b also changes the image displayed on the display 3b based on an event caused by a hand H b of a user, for example.

Thereby, the image rendered on the display 3a of the apparatus 2a at one location is also displayed on the display 3b of the apparatus 2b at the other location. Further, the image rendered on the display 3b of the apparatus 2b at the other location is displayed on the display 3a of the apparatus 2a at the one location. Thus enabling a remote sharing process to share the same image between remote locations, the communication system 1 is convenient for use in a meeting between remote locations, for example.

In the following description, any one of the apparatuses 2a and 2b will be referred to as the apparatus 2, and any one of the displays 3a and 3b will be referred to as the display 3. Further, any one of the electronic pens 4a and 4b will be referred to as the electronic pen 4, and any one of the USB memories 5a and 5b will be referred to as the USB memory 5. Similarly, any one of the laptops PC 6a and 6b will be referred to as the laptop PC 6, and any one of the teleconference terminals 7a and 7b will be referred to as the teleconference terminal 7. Further, any one of the hands H a and H b of the users will be referred to as the hand H, and any one of the cables 10a1, 10a2, 10b1, and 10b2 will be referred to as the cable 10.

In the first embodiment, an interactive whiteboard is described as an example of the apparatus 2. However, the apparatus 2 is not limited thereto. Other examples of the apparatus 2 include an electronic billboard (digital signage), a telestrator used in sports news or weathercast (i.e., a technology of combining handwriting or hand drawing with an image displayed on a monitor), and a remote diagnostic imaging system. The apparatus 2 may also be a headset device such as virtual reality (VR) goggles, augmented reality (AR) goggles, or mixed reality (MR) goggles.

Further, in the first embodiment, the laptop PC 6 is described as an example of an external device. However, the external device is not limited thereto. Other examples of the external device include terminals that supply image frames, such as a desktop PC, a tablet PC, a smartphone, a digital video camera, a digital camera, and a gaming machine. The communication network 9 includes the Internet, a local area network (LAN), and a mobile phone communication network. In the first embodiment, the USB memory 5 is described as an example of a recording medium. However, the recording medium is not limited thereto. Other examples of the recording medium include various recording media such as a secure digital (SD) card.

An exemplary hardware configuration of the apparatus 2 will be described.

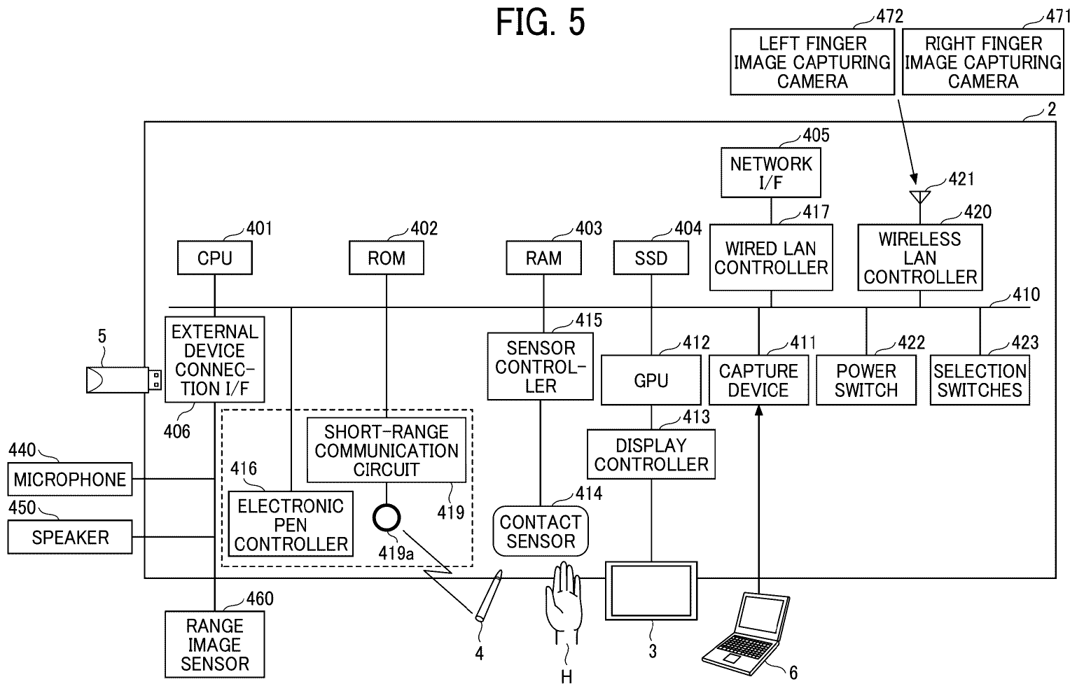

FIG. 5 is a diagram illustrating a hardware configuration of the apparatus 2. As illustrated in FIG. 5, the apparatus 2 includes a central processing unit (CPU) 401, a read only memory (ROM) 402, a random access memory (RAM) 403, a solid state drive (SSD) 404, a wired LAN controller 417, a network interface (I/F) 405, a wireless LAN controller 420, an antenna 421, and an external device connection I/F 406.

The CPU 401 controls overall operation of the apparatus 2. The ROM 402 stores programs used to start an operating system (OS), such as an initial program loader (IPL). The RAM 403 is used as a work area of the CPU 401. The SSD 404 stores various data such as programs for the apparatus 2. Via the network I/F 405, the wired LAN controller 417 controls communication with another apparatus connected to the communication network 9. The wireless LAN controller 420 executes a communication protocol conforming to the institute of electrical and electronics engineers (IEEE) 802.11ax standard to transmit and receive radio waves via the antenna 421 to control communication with a right finger image capturing camera 471 and a left finger image capturing camera 472. The external device connection I/F 406 is an interface for connecting various external devices to the apparatus 2. The external devices in this case include, for example, the USB memory 5 and externally attached devices (e.g., a microphone 440, a speaker 450, and a range image sensor 460). Alternatively, these externally attached devices may be built in the apparatus 2.

The range image sensor 460 has an array structure of 500×500 pairs of infrared laser diodes and light-receiving elements, for example. The range image sensor 460 measures the range based on the time taken from the emission of light from the infrared laser diodes to the reception of the light reflected back. The range image sensor 460, which includes an imaging device with a particular resolution to detect gradations of luminance, outputs range image data from the 500×500 pairs of infrared laser diodes and light-receiving elements at a speed of 30 frames per second (fps) to 60 fps. The range image sensor 460 may use a stereo camera or a light detection and ranging (LiDAR). The range image data includes at least one of range data or image data. Hereinafter, the range image data may be simply referred to as the image data.

Each of the right finger image capturing camera 471 and the left finger image capturing camera 472 is an image capturing device that captures an image of a finger of a user stretched to display a pointer or a rendered line on the display 3. The right finger image capturing camera 471 captures an image of the finger from the right side, and the left finger image capturing camera 472 captures an image of the finger from the left side, as described later. The right finger image capturing camera 471 and the left finger image capturing camera 472 transmit image data of the captured image to the apparatus 2 via a wireless LAN. The right finger image capturing camera 471 and the left finger image capturing camera 472 may alternatively transmit the image data to the apparatus 2 via a wired LAN, for example.

The apparatus 2 further includes a capture device 411, a graphics processing unit (GPU) 412, a display controller 413, a contact sensor 414, a sensor controller 415, an electronic pen controller 416, a short-range communication circuit 419, an antenna 419a for the short-range communication circuit 419, a power switch 422, and selection switches 423.

The capture device 411 displays display information of a display of the externally attached PC 6 as a still or video image. The GPU 412 is a semiconductor chip dedicated to graphics. The display controller 413 controls and manages screen display to output an image from the GPU 412 to the display 3, for example. The contact sensor 414 detects contact on the display 3 by the electronic pen 4 or the hand H of the user, for example. The sensor controller 415 performs a process of identifying the coordinates of the contact position based on a signal from the contact sensor 414. The contact sensor 414 detects input coordinates with an infrared blocking method. The input coordinates are detected with two light emitting and receiving devices disposed on opposite end portions of an upper part of the display 3. In each of the light emitting and receiving devices, a light emitting device (e.g., a laser) emits an infrared beam parallel to the display 3 to perform 90-degree rotational scanning. The infrared beam is reflected by a reflecting member disposed around the display 3. A light receiving device of the light emitting and receiving device receives the reflected infrared beam returning on the optical path of the emitted infrared beam. The light emitting and receiving devices forming the contact sensor 414 output to the sensor controller 415 the information of two positions on the light receiving devices at which the infrared beam is blocked by an object. Based on the information of the two positions, the sensor controller 415 identifies the coordinate position corresponding to the contact position of the object. The electronic pen controller 416 determines whether the head or end of the electronic pen 4 has touched the display 3 based on data input through communication between the short-range communication circuit 419 and the electronic pen 4 in accordance with the Bluetooth® standard. The short-range communication circuit 419 is a communication circuit conforming to a standard such as near field communication (NFC) or Bluetooth®. The power switch 422 is a switch for turning on or off the power supply of the apparatus 2. The selection switches 423 are a set of switches for adjusting the brightness and color tone of the image displayed on the display 3, for example.

The apparatus 2 further includes a bus line 410. The bus line 410 includes address buses and data buses for electrically connecting the CPU 401 and the other components in FIG. 5 to each other.

The contact sensor 414 is not limited to the infrared blocking method. The contact sensor 414 may be a capacitive touch panel that identifies the contact position by detecting a change in electrostatic capacitance. The contact sensor 414 may also be a resistance-film touch panel that identifies the contact position based on a change in voltage of two facing resistance films, or may be an electromagnetic induction touch panel that identifies the contact position by detecting electromagnetic induction caused by the contact of an object with a display unit. Various other detection means may be used as the contact sensor 414. The electronic pen controller 416 may also determine whether the display 3 has been touched by a portion of the electronic pen 4 held by the user or any other portion of the electronic pen 4, as well as the head or end of the electronic pen 4.

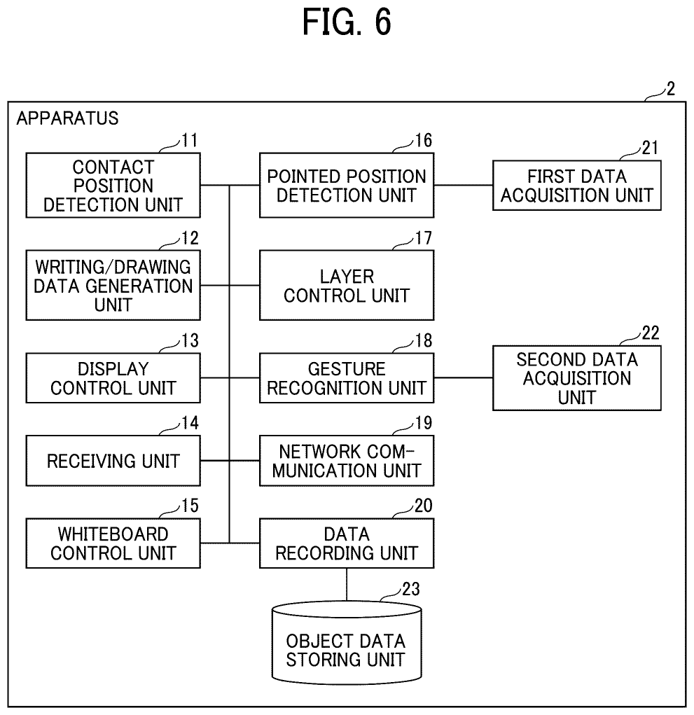

Functions of the apparatus 2 will be described with reference to FIG. 6.

FIG. 6 is a functional block diagram illustrating functional blocks of the apparatus 2. The apparatus 2 includes a contact position detection unit 11, a writing/drawing data generation unit 12, a display control unit 13, a receiving unit 14, a whiteboard control unit 15, a pointed position detection unit 16, a layer control unit 17, a gesture recognition unit 18, a network communication unit 19, a data recording unit 20, a first data acquisition unit 21, a second data acquisition unit 22, and an object data storing unit 23.

The contact position detection unit 11 converts the position of the touch by the electronic pen 4 or a finger into coordinates. The writing/drawing data generation unit 12 acquires, from the contact position detection unit 11, the coordinates of the contact position of the tip of the electronic pen 4 or the finger. The writing/drawing data generation unit 12 further acquires, from the pointed position detection unit 16, coordinates pointed by the user with the forefinger. The writing/drawing data generation unit 12 performs interpolation on a sequence of points of these coordinates to connect the coordinate points and generate a drawn line. The display 3 displays the drawn line input in handwriting on the touch panel with the electronic pen 4 or the finger.

The display control unit 13 causes the display 3 to display a drawn line, text converted from a drawn line, or an operation menu for the user to perform an operation, for example. The receiving unit 14 receives the pressing of a menu item based on the coordinates of the contact position of the electronic pen 4 or the finger or the coordinates calculated by the pointed position detection unit 16.

The whiteboard control unit 15 performs overall control of a whiteboard application, such as starting the whiteboard application, executing an authentication process, displaying a menu, communicating with another apparatus at a remote location, and storing data.

The first data acquisition unit 21 acquires the image data from each of the right finger image capturing camera 471 and the left finger image capturing camera 472. The pointed position detection unit 16 is a means for analyzing the image data of the images captured by the right finger image capturing camera 471 and the left finger image capturing camera 472, and detecting the coordinates on the display 3 pointed by the forefinger of the user. Specifically, the pointed position detection unit 16 analyzes the image data acquired by the first data acquisition unit 21, and calculates the coordinates of a point of intersection where an extension of the stretched forefinger of the user meets the plane of the display 3. Thereby, the user handwrites a line, for example, with a gesture operation.

The layer control unit 17 controls the transition of the mode based on the gesture operation recognized by the gesture recognition unit 18. The transition of the mode may take place in response to a menu operation, for example, instead of the gesture operation.

The second data acquisition unit 22 is a means for acquiring information related to the shape of a hand of the user from a sensor that acquires the information. The range image data includes the information related to the shape of the hand of the user. The information related to the shape of the hand of the user is at least one of luminance information or range information (three-dimensional information). Specifically, the second data acquisition unit 22 acquires the range image data from the range image sensor 460.

The gesture recognition unit 18 is a means for recognizing, based on the range image data acquired by the range image sensor 460, a gesture operation recognizable in one of at least three layers in which a plurality of gesture operations are classified. Specifically, the gesture recognition unit 18 recognizes a gesture operation performed by the user based on the range image data acquired by the second data acquisition unit 22. The gesture recognition unit 18 recognizes a recognizable gesture operation previously set in one of the modes. If the gesture recognition unit 18 recognizes the first gesture operation in the top layer, the gesture recognition unit 18 becomes ready to recognize a gesture operation classified in the second layer. If the gesture recognition unit 18 recognizes the second gesture operation in the second layer, the gesture recognition unit 18 becomes ready to recognize a gesture operation classified in the third layer.

The network communication unit 19 is connected to the communication network 9 to communicate data with another apparatus 2, a server apparatus, or an external device.

The data recording unit 20 stores data such as handwriting data of handwriting input to the apparatus 2, converted text, PC screen data, or a file in the object data storing unit 23. The data recording unit 20 further stores, in the object data storing unit 23, training data used to detect the palm of the hand by machine learning (i.e., the range image data of the palm of the hand).

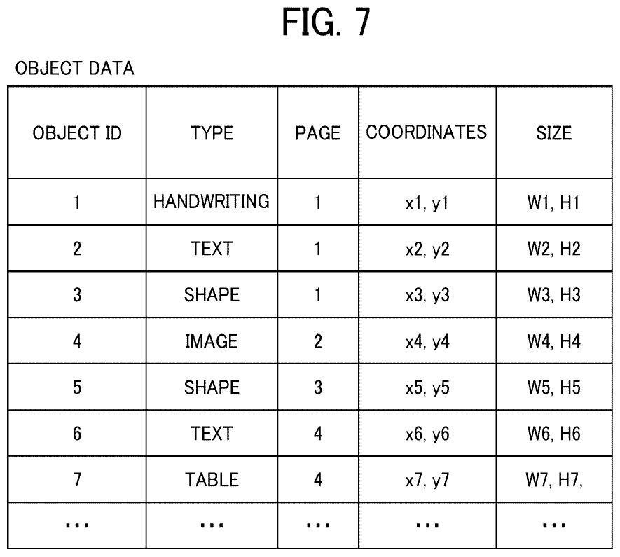

FIG. 7 is a table illustrating object data stored in the object data storing unit 23. An item “object identifier (ID)” is identification information for identifying display data. An item “type” represents the type of the object data, such as handwriting, text, shape, image, or table. Herein, handwriting refers to stroke data (a sequence of coordinate points). Text refers to one or more characters or symbols (character codes) converted from handwriting data. Shape refers to a geometric shape converted from handwriting data, such as triangle or square. Image refers to image data in an image format such as joint photographic experts group (JPEG), portable network graphics (PNG), or tagged image file format (TIFF) obtained from a PC or the Internet, for example. Table refers to a one- or two-dimensional object in table format.

Herein, a screen of the apparatus 2 is referred to as a page. An item “page” represents the page number of the page. An item “coordinates” indicates the position of the object data with reference to a particular origin on the apparatus 2. For example, the position of the object data corresponds to the upper-left vertex of a circumscribed rectangle around the object data. Herein, the coordinates are expressed in pixel units of the display 3, for example. An item “size” includes the width and height of the circumscribed rectangle around the object data.

The transition of the mode in the apparatus 2 of the first embodiment and the gesture operations recognizable in the modes will be described in detail.

0. Gesture recognition mode: If the apparatus 2 in the initial state recognizes the palm of a hand, the apparatus 2 transitions to the gesture recognition mode.

1. Pointer mode: If the apparatus 2 in the gesture recognition mode recognizes that the user has performed the gesture operation of swinging the palm of a hand upward, the apparatus 2 transitions from the gesture recognition mode to the pointer mode. The pointer mode is a mode to recognize the forefinger and calculate the coordinates of a pointer on the display 3. In the pointer mode, the user may move the mouse cursor or press a menu button. If the apparatus 2 recognizes a previously set gesture operation in the pointer mode, the apparatus 2 transitions to one of the following modes in 2-1, 2-2, and 2-3. The pointer mode ends with the gesture operation of swinging the palm of a hand downward.

2-1. Pen mode: If the apparatus 2 recognizes that the user has performed the gesture operation of swinging two fingers horizontally, the apparatus 2 transitions to the pen mode. The user then points the forefinger at the display 3 to write or draw or to move a pen icon and press a menu button. The pen mode ends when the apparatus 2 recognizes that the user has performed the gesture operation of closing the forefinger.

2-2. Marker mode: If the apparatus 2 recognizes that the user has performed the gesture operation of swinging three fingers horizontally, the apparatus 2 transitions to the marker mode. The user then points the forefinger at the display 3 to write or draw with a marker or to move a marker icon and press a menu button. The marker automatically disappears when a certain time (e.g., five seconds) passes after the writing or drawing. The marker mode ends when the apparatus 2 recognizes that the user has performed the gesture operation of closing the forefinger.

2-3. Eraser mode: If the apparatus 2 recognizes that the user has performed the gesture operation of swinging three fingers vertically, the apparatus 2 transitions to the eraser mode. The user then points the forefinger at the display 3 to erase a drawn line or to move an eraser icon and press a menu button. The eraser mode ends when the apparatus 2 recognizes that the user has performed the gesture operation of closing the forefinger.

The layer control unit 17 may cause transition between the pen mode, the marker mode, and the eraser mode in the same layer in response to a gesture operation performed by the user. Thereby, the user does not need to return to the pointer mode. If the user wants to return to the pointer mode and then come back to the pen mode, the marker mode, or the eraser mode, the user simply closes the forefinger and performs again the gesture operation for transitioning to the pen mode, the marker mode, or the eraser mode. An operational load on the user in this operation is less than that in a menu operation, for example. In another application with different modes, a gesture operation for transitioning between layers may be the same as the gesture operation for transitioning from the pointer mode to the pen mode, the marker mode, or the eraser mode.

3. Page switching: Page switching is available in each of the pointer mode, the pen mode, the marker mode, and the eraser mode. This is because limiting page switching to a particular mode involves an extra gesture operation for the user to shift the mode for page switching. If the apparatus 2 recognizes that the user has performed the gesture operation of swinging four fingers to the left, the apparatus 2 returns to the previous page. If the apparatus 2 recognizes that the user has performed the gesture operation of swinging four fingers to the right, the apparatus 2 proceeds to the next page.

The apparatus 2 of the first embodiment thus detects, through image analysis, the shape and motion of a distal part from the wrist, such as the palm of a hand, N fingers (N is a number selected from 1 to 4), or a closed hand of the user.

The recognition of the palm of a hand and the gesture operations will be described.

A method of recognizing the palm of a hand performed by the gesture recognition unit 18 will first be described.

Developers of the manufacturer of the apparatus 2 previously extract range image data obtained by capturing images of palms of hands with the range image sensor 460 (i.e., three-dimensional data and luminance data of the palms of the hands), and store the extracted range image data in a storage unit. The developers capture images of palms of hands of many people to store range image data of many palms of hands in the storage unit.

When recognizing the palm of a hand of the user, the gesture recognition unit 18 detects a moving object from the range image data input from the range image sensor 460, and compares the range image data of the object with the previously stored range image data of the palms of the hands. The moving object is detected as a changed part of the range image. If the degree of similarity of the compared range image data to the stored range image data is equal to or greater than a threshold value, the gesture recognition unit 18 determines that the object is the palm of a hand. That is, the gesture recognition unit 18 performs pattern matching. If the gesture recognition unit 18 recognizes the palm of a hand, the apparatus 2 transitions to the gesture recognition mode. Having transitioned to the gesture recognition mode, the gesture recognition unit 18 becomes ready to recognize the gesture operation for transitioning to the pointer mode, the pen mode, the marker mode, or the eraser mode.

Preferably, a machine-learned model is used in the above-described image analysis to detect the palm of a hand from the range image data.

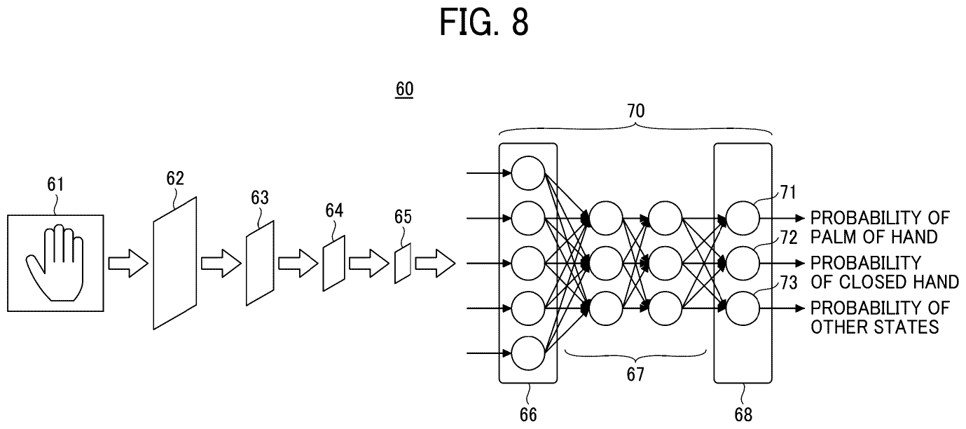

FIG. 8 schematically illustrates a model for detecting the state of a hand (e.g., the palm of a hand) from the range image data. FIG. 8 illustrates an exemplary configuration of a palm recognition model using a convolutional neural network (CNN) 60, for example. The CNN 60 includes convolutional layers 62 and 64, pooling layers 63 and 65, and a fully connected layer 70, for example. An input image 61 is the range image data of an image captured by the range image sensor 460. The range image data includes, as well as pixel values, range data corresponding to pixels. The input image 61 is sequentially processed through the convolutional layer 62, the pooling layer 63, the convolutional layer 64, the pooling layer 65, and the fully connected layer 70 in this order.

The convolutional layers 62 and 64 are filters for extracting features. The pooling layers 63 and 65 involve a process of aggregating the values in each local area (i.e., window) of a feature map into a representative value. Examples of this process include maximum pooling to select the maximum value from the window and average pooling to select the average value from the window.

An output from the pooling layer 65 is input to the fully connected layer 70. The fully connected layer 70 is called a neural network. In the neural network, L layers are fully connected from nodes of an input layer 66 to nodes of an output layer 68. A neural network with multiple layers between an input layer and an output layer is called a deep neural network (DNN). Layers between the input layer 66 and the output layer 68 are called intermediate layers (hidden layers) 67. The number of the intermediate layers 67 and the number of nodes in each of the layers described here are illustrative and not limiting.

In the first embodiment, a classification model is generated to identify the palm of a hand or a closed hand with the forefinger closed, for example (a regression model is another type of model). In the model for detecting the state of the hand, therefore, the output layer 68 includes nodes corresponding to the palm of a hand, a closed hand, and other states. In FIG. 8, the output layer 68 includes three nodes. However, the number of nodes varies depending on the number of states of the hand to identify.

In the classification model, probabilities associated with the nodes of the output layer 68 are typically output from the nodes. In FIG. 8, therefore, the output layer 68 outputs the respective probabilities of the states associated with the nodes, such as the probability of the palm of a hand associated with a node 71, the probability of a closed hand associated with a node 72, and the probability of other states associated with a node 73. Alternatively, the classification model may be generated to recognize the forefinger, two fingers, three fingers, and four fingers.

In a learning phase of the model, range image data already identified as representing a state of the palm of the hand is provided. In a vector of training data, a node corresponding to the palm of the hand captured in the range image data has a value “1,” and the other nodes has a value “0.” For example, if range image data already identified as representing the palm of a hand is input to the model, the node 71 has the value “1,” and the other nodes 72 and 73 have the value “0.” A learning machine (i.e., an information processing device) calculates the difference between the training data and the probability output from each of the nodes 71 to 73 of the output layer 68 by using a loss function, and transmits the difference to the input layer 66 with error backpropagation. With error backpropagation, connection weights between nodes are learned, gradually improving the accuracy of the probabilities output from the nodes 71 to 73 of the output layer 68.

In an inference phase of the model, with input of the range image data of the palm of a hand, for example, the node 71 of the output layer 68 corresponding to the palm of a hand is expected to output a probability close to the value “1,” and the other nodes 72 and 73 are expected to output a probability close to the value “0.” The gesture recognition unit 18 identifies (infers) the state of the hand corresponding to one of the nodes 71 to 73 with the highest probability.

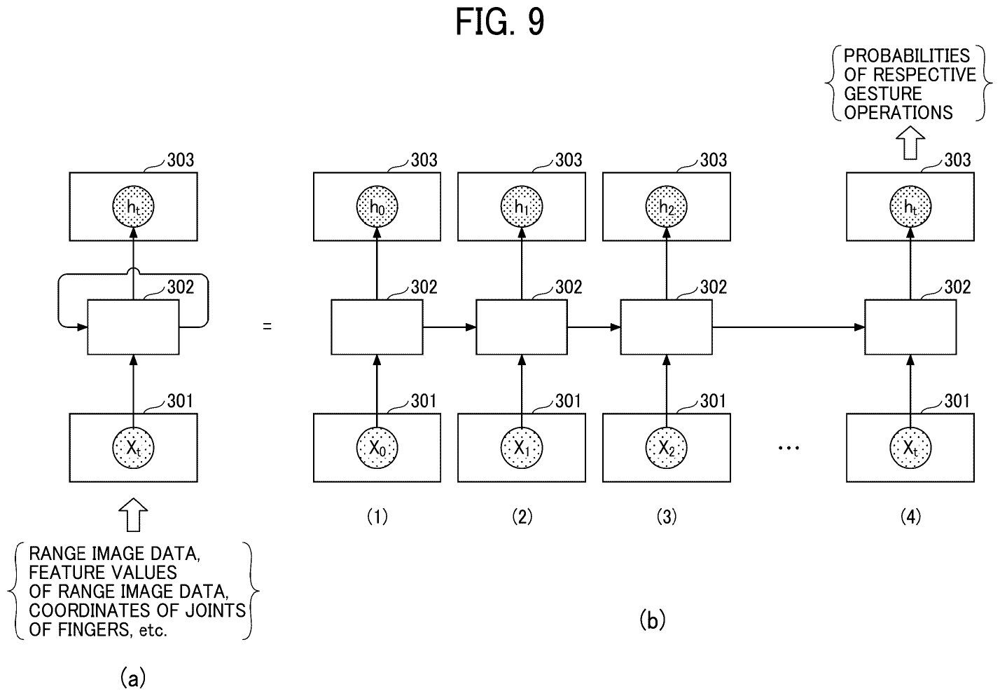

As a model for detecting a human motion, there is a model that detects the motion from chronological data. FIG. 9 is a diagram illustrating a configuration of a gesture recognition model. An exemplary configuration of the gesture recognition model will be described here with a long short term memory (LSTM) as an example. The LSTM is effective in recognizing chronological data. For example, the motion of swinging the palm of a hand upward or downward is identified based not on the state of the hand at a certain moment but on the chronological state of the hand. It is therefore preferable to use a model suitable for chronological data.

In FIG. 9, (a) illustrates a data flow of an LSTM, and (b) illustrates a breakdown of the data flow in (a). An LSTM neural network includes three layers: an input layer 301, an intermediate layer 302, and an output layer 303. The intermediate layer 302 may include one or more fully connected layers, for example. The LSTM neural network outputs the result of an arithmetic operation in the intermediate layer 302 to the output layer 303. The LSTM neural network also inputs the result of the arithmetic operation back to the intermediate layer 302 to use the result in the next arithmetic operation. Substituting the result of the arithmetic operation in the intermediate layer 302 back to the intermediate layer 302 is illustrated in (b) of FIG. 9 with the input layer 301, the intermediate layer 302, and the output layer 303 arranged chronologically. With the intermediate layer 302 carrying over past data, the LSTM neural network retains past memories (i.e., feature values of past range image data in the present embodiment).

Input data to the input layer 301 may be the range image data, the feature values of the range image data, or the coordinates of joints in the palm of the hand, for example. A process of detecting the coordinates of the joints in the palm of the hand from the range image data may be performed with an existing model. For example, input data xₜ input to the input layer 301 is a vector that includes, as elements, the two-dimensional coordinates of the first to third joints of the four fingers and the first and second joints of the thumb. Herein, the subscript “t” represents the number of inputs of the input data.

In (1) of FIG. 9, the result of the arithmetic operation on input data x₀ in the intermediate layer 302 is both output data h₀ and input data x₁ to the intermediate layer 302.

In (2) of FIG. 9, the result of the arithmetic operation on input data x₁ in the intermediate layer 302 is both output data h₁ and input data x₂ to the intermediate layer 302.

In (3) of FIG. 9, the result of the arithmetic operation on input data x₂ in the intermediate layer 302 is both output data h₂ and input data x₃ to the intermediate layer 302.

In (4) of FIG. 9, the result of the arithmetic operation on input data xₜ in the intermediate layer 302 is both output data hₜ and input data xₜ₊₁ to the intermediate layer 302.

The output data hₜ output from the output layer 303 is a vector including the same number of elements as the gesture operations to identify, for example. For instance, the gesture operations to identify may be the motion of swinging the palm of a hand upward, showing the forefinger, the motion of swinging two fingers horizontally, the motion of swinging three fingers horizontally, the motion of swinging three fingers vertically, the motion of swinging four fingers to the left, and the motion of swinging four fingers to the right. In this case, the output data is a vector including seven elements corresponding to the probabilities of these gesture operations. If the actual gesture operation is the motion of swinging the palm of a hand upward, one of the elements of the output data corresponding to this gesture operation is expected to be close to the value “1,” as in (1, 0, 0, 0, 0, 0, 0), for example.

Learning methods of the LSTM include back propagation through time (BPTT) and real time recurrent learning (RTRL). The input data is the coordinates of each of the joints, for example. The training data is a one-hot vector in which the value “1” is limited to an element corresponding to a gesture operation with an annotation (description of a bodily motion). Weights on the connections between the input layer 301, the intermediate layer 302, and the output layer 303 and weights on the connection from the intermediate layer 302 back to the intermediate layer 302 are adjusted with error backpropagation to propagate the difference between the output value from each of the nodes of the output layer 303 and each of the elements of the on-hot vector.

The gesture recognition method illustrated in FIG. 9 is illustrative. Spatial-temporal graph convolutional networks (ST-GCN), a model using attention mechanism, support vector machine, logistic regression, decision tree, or random forest may also be used as a recognition algorithm.

Various gesture operations recognized in the gesture recognition mode and other modes will be described.

The gesture recognition unit 18 recognizes the following gesture operations in the respective modes. Simply showing a shape without any hand motion is also a gesture operation.

Recognition of the operation of swinging the palm of a hand upward in the gesture recognition mode: If the gesture recognition unit 18 recognizes that the recognized palm of the hand (hereinafter referred to as the palm object regardless of the direction of the palm of the hand or whether the hand is closed or not) has moved upward by a particular distance, the gesture recognition unit 18 identifies a gesture operation for starting the pointer mode.

Recognition of the index finger (the forefinger) in the pointer mode, the pen mode, the marker mode, or the eraser mode: The gesture recognition unit 18 tracks the movement of the palm object. Then, if the gesture recognition unit 18 recognizes that the palm object has changed into a shape with one finger (e.g., the forefinger) stretched, the gesture recognition unit 18 identifies a gesture operation for displaying a pointer at the coordinates on the display 3 pointed by the forefinger.

Recognition of the index finger and the middle finger (two fingers) in the pointer mode: The gesture recognition unit 18 tracks the movement of the palm object. Then, if the gesture recognition unit 18 recognizes that the palm object has changed into a shape with two fingers stretched and that the palm object has been swung horizontally, the gesture recognition unit 18 identifies a gesture operation for starting the pen mode.

Recognition of the index finger, the middle finger, and the ring finger (three fingers) in the pointer mode: The gesture recognition unit 18 tracks the movement of the palm object. Then, if the gesture recognition unit 18 recognizes that the palm object has changed into a shape with three fingers stretched and that the palm object has been swung horizontally, the gesture recognition unit 18 identifies a gesture operation for starting the marker mode.

Recognition of the index finger, the middle finger, and the ring finger (three fingers) in the pointer mode: The gesture recognition unit 18 tracks the movement of the palm object. Then, if the gesture recognition unit 18 recognizes that the palm object has changed into a shape with three fingers stretched and that the palm object has been swung vertically, the gesture recognition unit 18 identifies a gesture operation for starting the eraser mode.

Recognition of the index finger, the middle finger, the ring finger, and the little finger (four fingers) in the pointer mode, the pen mode, the marker mode, or the eraser mode: The gesture recognition unit 18 tracks the movement of the palm object. Then, if the gesture recognition unit 18 recognizes that the palm object has changed into a shape with four fingers stretched and that the palm object has been swung to the left, the gesture recognition unit 18 identifies a gesture operation for switching the page of a whiteboard displayed on the displayed 3 to the previous page. Further, if the gesture recognition unit 18 recognizes that the palm object has been swung to the right, the gesture recognition unit 18 identifies a gesture operation for switching the page of the whiteboard displayed on the display 3 to the next page.

Recognition of the operation of swinging the palm of a hand downward in the pointer mode: If the gesture recognition unit 18 recognizes that the palm of the hand has been swung downward in the pointer mode, the gesture recognition unit 18 identifies a gesture operation for ending the pointer mode.

Recognition of closing a hand in the pointer mode, the pen mode, the marker mode, or the eraser mode: If the gesture recognition unit 18 recognizes that the palm object has changed into a shape with the forefinger closed in the pointer mode, the pen mode, the marker mode, or the eraser mode, the gesture recognition unit 18 identifies a gesture operation for ending the current mode.

Recognition of the index finger and the thumb in the pointer mode, the pen mode, the marker mode, or the eraser mode: If the gesture recognition unit 18 recognizes that the thumb has been stretched with the mouse cursor being displayed at the coordinates pointed by the forefinger in the pointer mode, the gesture recognition unit 18 recognizes a gesture operation for bringing a virtual pen into contact with the touch panel. Further, if the gesture recognition unit 18 recognizes that the palm object in this state has changed into a shape with the thumb closed, the gesture recognition unit 18 identifies a gesture operation for releasing the virtual pen from the touch panel.

In the pen mode, if the gesture recognition unit 18 recognizes that the thumb has been stretched with the pen icon being displayed at the coordinates pointed by the forefinger, the gesture recognition unit 18 recognizes a gesture operation for pen-down. If the gesture recognition unit 18 recognizes that the palm object in this state has changed into a shape with the thumb closed, the gesture recognition unit 18 identifies a gesture operation for pen-up. A pen-up mode refers to a mode in which a pen is not in contact with the touch panel. In the pen-up mode, writing or drawing does not take place even if the pen icon is moved. A pen-down mode refers to a mode in which the pen is in contact with the touch panel. In the first embodiment, the pen-down mode refers to the state in which writing or drawing takes place, although a physical pen is not used.

In the marker mode, if the gesture recognition unit 18 recognizes that the thumb has been stretched with the marker icon being displayed at the coordinates pointed by the forefinger, the gesture recognition unit 18 recognizes the gesture operation for pen-down. In the pen-down mode, if the gesture recognition unit 18 recognizes that the palm object has changed into a shape with the thumb closed, the gesture recognition unit 18 identifies the gesture operation for pen-up.

In the eraser mode, if the gesture recognition unit 18 recognizes that the thumb has been stretched with the eraser icon being displayed at the coordinates pointed by the forefinger, the gesture recognition unit 18 recognizes a gesture operation for bringing the virtual eraser into contact with the display 3. In the mode in which the virtual eraser is in contact with the display 3, if the gesture recognition unit 18 recognizes that the palm object has changed into a shape with the thumb closed, the gesture recognition unit 18 identifies a gesture operation for releasing the virtual eraser from the display 3.

Displaying the pointer at the pointed position will be described.

The calculation of the coordinates on the display 3 pointed by the user will first be described with reference to FIG. 10 and other drawings.

FIG. 10 is a diagram illustrating an exemplary layout of the right finger image capturing camera 471 and the left finger image capturing camera 472. The right finger image capturing camera 471 and the left finger image capturing camera 472 are cameras for detecting the pointed coordinates on the display 3. In FIG. 10, the right finger image capturing camera 471 is placed near a table, and the left finger image capturing camera 472 is placed on the table. It suffices if the right finger image capturing camera 471 and the left finger image capturing camera 472 capture images of the display 3 and distal parts from the wrists of users. Therefore, the right finger image capturing camera 471 and the left finger image capturing camera 472 may be built in an upper or lower part of the apparatus 2. Further, the right finger image capturing camera 471 and the left finger image capturing camera 472 may be built in or externally attached to the apparatus 2. Each of the right finger image capturing camera 471 and the left finger image capturing camera 472 may be a camera that acquires an image and the range information of an object to facilitate the gesture recognition unit 18 and the pointed position detection unit 16 to identify the state of the fingers (e.g., how many fingers are shown).

Preferably, at least two finger image capturing cameras, i.e., the right finger image capturing camera 471 and the left finger image capturing camera 472, are provided. Alternatively, three or more finger image capturing cameras may be placed. The apparatus 2 selects two image data items suitable for hand recognition from three or more image data items received from the right finger image capturing camera 471 and the left finger image capturing camera 472. Alternatively, the apparatus extracts two image data items from all image data items received from the right finger image capturing camera 471 and the left finger image capturing camera 472. The apparatus 2 further calculates the pointed coordinates with a combination of the two image data items, and uses the mean of the calculated coordinates. Each of the right finger image capturing camera 471 and the left finger image capturing camera 472 may be a spherical camera.

A process to display the pointer at a position on the display 3 pointed by the user will be described. This process also uses the image data received from the right finger image capturing camera 471 and the left finger image capturing camera 472.

In the pointer mode, the pen mode, the marker mode, or the eraser mode, if the gesture recognition unit 18 recognizes that the hand shape has changed into a shape with one finger (e.g., the forefinger) stretched, the gesture recognition unit 18 transmits to the pointed position detection unit 16 a command to start an operation of calculating the pointed position on the display 3. Similarly as in the process of the gesture recognition unit 18, the pointed position detection unit 16 uses a model generated by machine learning to extract an object such as a hand from the image captured by the right finger image capturing camera 471, and determines that the object is a hand with one finger stretched.

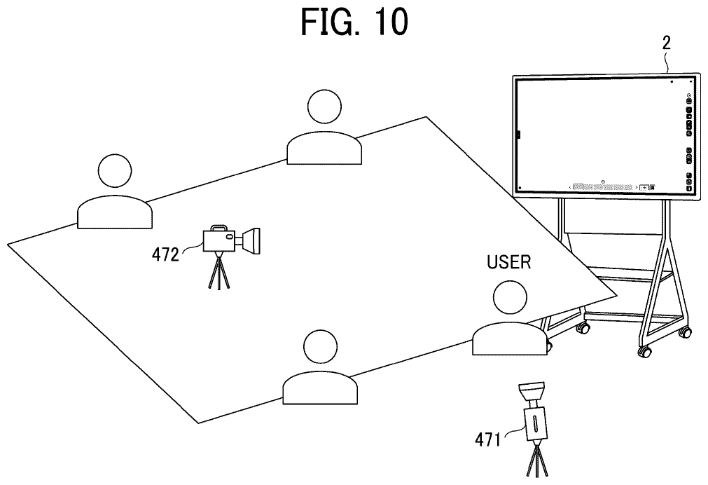

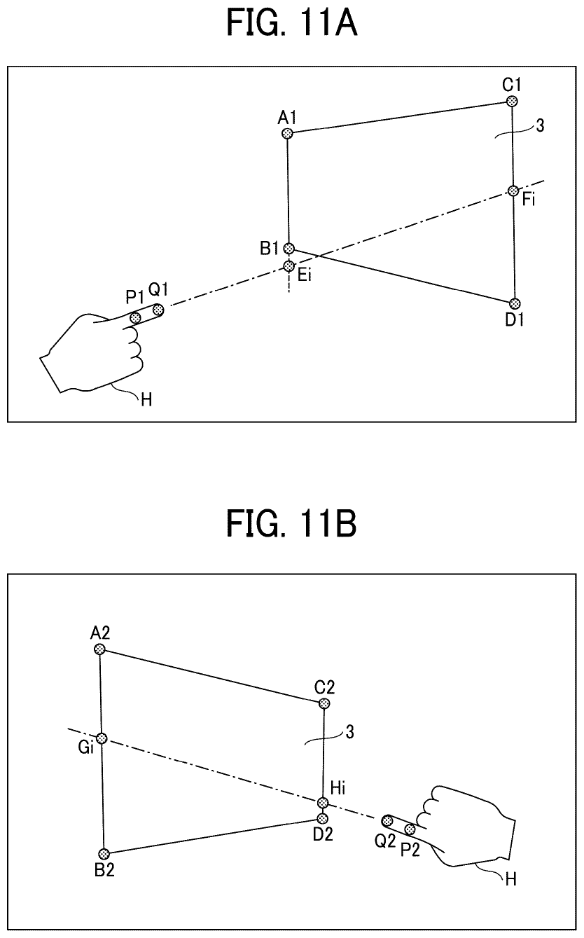

In response to receipt of the command, the pointed position detection unit 16 starts the operation of calculating the pointed coordinates on the display 3 with the image data received from the right finger image capturing camera 471 and the left finger image capturing camera 472 via the wireless LAN. FIG. 11A illustrates the image captured by the right finger image capturing camera 471 (hereinafter referred to as the right captured image). FIG. 11B illustrates the image captured by the left finger image capturing camera 472 (hereinafter referred to as the left captured image).

The pointed position detection unit 16 then identifies the base of the forefinger (represented by a point P1 in FIG. 11A) and the tip of the forefinger (represented by a point Q1 in FIG. 11A) from the right captured image. The pointed position detection unit 16 further compares shape data of an object extracted from the right captured image with previously stored shape data of the display 3 of the apparatus 2, and determines that the object is the display 3 of the apparatus 2. This determination process may also use a model generated by machine learning. In the right captured image of FIG. 11A, points A1, B1, C1, and D1 represent an upper-left corner, a lower-left corner, an upper-right corner, and a lower-right corner of the display 3 of the apparatus 2, respectively. Further, in the right captured image of FIG. 11A, a point Ei represents the point of intersection of an extension of a line segment P1Q1 and an extension of a line segment A1B1, and a point Fi represents the point of intersection of the extension of the line segment P1Q1 and a line segment C1D1.

The pointed position detection unit 16 identifies the hand with the one finger stretched from the left captured image in a similar manner as described above. The pointed position detection unit 16 further identifies the base of the stretched finger (represented by a point P2 in FIG. 11B) and the tip of the finger (represented by a point Q2 in FIG. 11B). The pointed position detection unit 16 then identifies the display 3 of the apparatus 2 from the left captured image. In the left captured image of FIG. 11B, points A2, B2, C2, and D2 represent an upper-left corner, a lower-left corner, an upper-right corner, and a lower-right corner of the display 3 of the apparatus 2, respectively. Further, in the left captured image of FIG. 11B, a point Gi represents the point of intersection of an extension of a line segment P2Q2 and a line segment A2B2, and a point Hi represents the point of intersection of the extension of the line segment P2Q2 and a line segment C2D2.

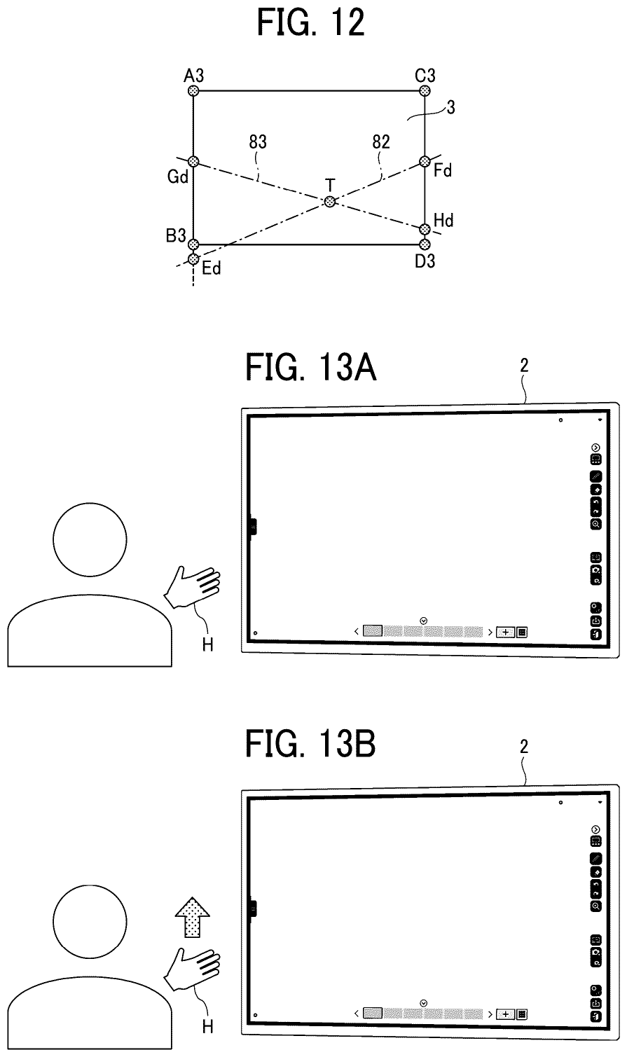

FIG. 12 is a front view of the display 3 of the apparatus 2. A point T on the display 3 of the apparatus 2 pointed by the user corresponds to the point of intersection of a line connecting the points Ei and Fi in the right captured image captured by the right finger image capturing camera 471 and a line connecting the points Gi and Hi in the left captured image captured by the left finger image capturing camera 472. Coordinates in the captured images are based on the pixel positions in the captured images. To display the pointer at the pointed position, therefore, these coordinates are converted into coordinates based on the pixel positions in the display 3 of the apparatus 2.

Points A3, B3, C3, and D3 in FIG. 12 represent an upper-left corner, a lower-left corner, an upper-right corner, and a lower-right corner of the display 3 of the apparatus 2, respectively. Points Ed and Fd are coordinate points of the points Ei and Fi in the right captured image captured by the right finger image capturing camera 471, which are converted with a coordinate transformation matrix TR described below from the coordinates based on the pixel positions in the right captured image into the coordinates based on the display pixel positions in the display 3 of the apparatus 2. Points Gd and Hd are coordinate points of the points Gi and Hi in the left captured image captured by the left finger image capturing camera 472, which are converted with a coordinate transformation matrix TL described below from the coordinates based on the pixel positions in the left captured image into the coordinates based on the display pixel positions in the display 3 of the apparatus 2.

The coordinate transformation matrices TR and TL are calculated with equations given below.

A1 (a1x, a1y), B1 (b1x, b1y), C1 (c1x, c1y), and D1 (d1x, d1y) represent the coordinates of the upper-left corner, the lower-left corner, the upper-right corner, and the lower-right corner of the display 3 based on the pixel positions in the right captured image captured by the right finger image capturing camera 471. Further, A3 (a3x, a3y), B3 (b3x, b3y), C3 (c3x, c3y), and D3 (d3x, d3y) represent the coordinates of the upper-left corner, the lower-left corner, the upper-right corner, and the lower-right corner of the display 3 of the apparatus 2 based on the pixel positions in the display 3 of the apparatus 2. The coordinate transformation matrix TR in equation (1) is obtained with eight simultaneous equations given below.

$$a 3 x = ( R 11 * a 1 x + R 12 * a 1 y + R 13 ) / ( R 31 * a 1 x + R 32 * a 1 y + 1 )$$

$$a 3 y = ( R 21 * a 1 x + R 22 * a 1 y + R 23 ) / ( R 31 * a 1 x + R 32 * a 1 y + 1 )$$

$$b 3 x = ( R 11 * b 1 x + R 12 * b 1 y + R 13 ) / ( R 31 * b 1 x + R 32 * b 1 y + 1 )$$

$$b 3 y = ( R 21 * b 1 x + R 22 * b 1 y + R 23 ) / ( R 31 * b 1 x + R 32 * b 1 y + 1 )$$

$$c 3 x = ( R 11 * c 1 x + R 12 * c 1 y + R 13 ) / ( R 31 * c 1 x + R 32 * c 1 y + 1 )$$

$$c 3 y = ( R 21 * c 1 x + R 22 * c 1 y + R 23 ) / ( R 31 * c 1 x + R 32 * c 1 y + 1 )$$

$$d 3 x = ( R 11 * d 1 x + R 12 * d 1 y + R 13 ) / ( R 31 * d 1 x + R 32 * d 1 y + 1 )$$

$$d 3 y = ( R 21 * d 1 x + R 22 * d 1 y + R 23 ) / ( R 31 * d 1 x + R 32 * d 1 y + 1 )$$

$$\begin{matrix}[ Math . 1 ] & \\ TR = ( \begin{matrix}R 11 & R 12 & R 13 \\ R 21 & R 22 & R 23 \\ R 31 & R 32 & R 33\end{matrix} ) & ( 1 )\end{matrix}$$

A2 (a2x, a2y), B2 (b2x, b2y), C2 (c2x, c2y), and D2 (d2x, d2y) represent the coordinates of the upper-left corner, the lower-left corner, the upper-right corner, and the lower-right corner of the display 3 based on the pixel positions in the left captured image captured by the left finger image capturing camera 472. Further, A3 (a3x, a3y), B3 (b3x, b3y), C3 (c3x, c3y), and D3 (d3x, d3y) represent the coordinates of the upper-left corner, the lower-left corner, the upper-right corner, and the lower-right corner of the display 3 of the apparatus 2 based on the display pixel positions in the display 3 of the apparatus 2. The coordinate transformation matrix TL in equation (2) is obtained with eight simultaneous equations given below.

$$a 3 x = ( L 11 * a 2 x + L 12 * a 2 y + L 13 ) / ( L 31 * a 2 x + L 32 * a 2 y + 1 )$$

$$a 3 y = ( L 21 * a 2 x + L 22 * a 2 y + L 23 ) / ( L 31 * a 2 x + L 32 * a 2 y + 1 )$$

$$b 3 x = ( L 11 * b 2 x + L 12 * b 2 y + L 13 ) / ( L 31 * b 2 x + L 32 * b 2 y + 1 )$$

$$b 3 y = ( L 21 * b 2 x + L 22 * b 2 y + L 23 ) / ( L 31 * b 2 x + L 32 * b 2 y + 1 )$$

$$c 3 x = ( L 11 * c 2 x + L 12 * c 2 y + L 13 ) / ( L 31 * c 2 x + L 32 * c 2 y + 1 )$$

$$c 3 y = ( L 21 * c 2 x + L 22 * c 2 y + L 23 ) / ( L 31 * c 2 x + L 32 * c 2 y + 1 )$$

$$d 3 x = ( L 11 * d 2 x + L 12 * d 2 y + L 13 ) / ( L 31 * d 2 x + L 32 * d 2 y + 1 )$$

$$d 3 y = ( L 21 * d 2 x + L 22 * d 2 y + L 23 ) / ( L 31 * d 2 x + L 32 * d 2 y + 1 )$$

$$\begin{matrix}[ Math . 2 ] & \\ TL = ( \begin{matrix}L 11 & L 12 & L 13 \\ L 21 & L 22 & L 23 \\ L 31 & L 32 & L 33\end{matrix} ) & ( 2 )\end{matrix}$$

With the above-described coordinate transformation matrices TR and TL, the points Ei, Fi, Gi, and Hi in the captured images are converted into the points Ed, Fd, Gd, and Hd, respectively, represented by the coordinates of the display positions in the display 3 of the apparatus 2. Coordinate transformation equations for the points Ei, Fi, Gi, and Hi are given below as equations (3), (4), (5), and (6).

Equation (3) is used to convert the point Ei (eix, eiy) into the point Ed (edx, edy).

$$\begin{matrix}[ Math . 3 ] & \\ ( \begin{matrix}edtx \\ edty \\ edta\end{matrix} ) = ( \begin{matrix}R 11 & R 12 & R 13 \\ R 21 & R 22 & R 23 \\ R 31 & R 32 & R 33\end{matrix} ) ( \begin{matrix}eix \\ eiy \\ 1\end{matrix} ) & ( 3 )\end{matrix}$$

$$edx = edtx / edta$$

$$edy = edty / edta$$

Equation (4) is used to convert the point Fi (fix, fiy) into the point Fd (fdx, fdy).

$$\begin{matrix}[ Math . 4 ] & \\ ( \begin{matrix}fdtx \\ fdty \\ fdta\end{matrix} ) = ( \begin{matrix}R 11 & R 12 & R 13 \\ R 21 & R 22 & R 23 \\ R 31 & R 32 & R 33\end{matrix} ) ( \begin{matrix}fix \\ fiy \\ 1\end{matrix} ) & ( 4 )\end{matrix}$$

$$fdx = fdtx / fdta$$

$$fdy = fdty / fdta$$

Equation (5) is used to convert the point Gi (gix, giy) into the point Gd (gdx, gdy).

$$\begin{matrix}[ Math . 5 ] & \\ ( \begin{matrix}gdtx \\ gdty \\ gdta\end{matrix} ) = ( \begin{matrix}L 11 & L 12 & L 13 \\ L 21 & L 22 & L 33 \\ L 31 & L 32 & L 33\end{matrix} ) ( \begin{matrix}gix \\ giy \\ 1\end{matrix} ) & ( 5 )\end{matrix}$$

$$gdx = gdtx / gdta$$

$$gdy = gdty / gdta$$

Equation (6) is used to convert the point Hi (hix, hiy) into the point Hd (hdx, hdy).

$$\begin{matrix}[ Math . 6 ] & \\ ( \begin{matrix}hdtx \\ hdty \\ hdta\end{matrix} ) = ( \begin{matrix}L 11 & L 12 & L 13 \\ L 21 & L 22 & L 33 \\ L 31 & L 32 & L 33\end{matrix} ) ( \begin{matrix}hix \\ hiy \\ 1\end{matrix} ) & ( 6 )\end{matrix}$$

$$hdx = hdtx / hdta$$

$$hdy = hdty / hdta$$

In FIG. 12, the coordinates of the point T on the display 3 of the apparatus 2 pointed by the user corresponds to the point of intersection of a line segment EdFd and a line segment GdHd. Therefore, the equation of a straight line 82 including the line segment EdFd and the equation of a straight line 83 including the line segment GdHd are determined. The coordinates at which the point T is to be displayed are calculated with these simultaneous equations.

The relationships between several gesture operations and operations received by the apparatus 2 will be described with reference to FIGS. 13A to 37.

FIGS. 13A and 13B illustrate gesture operations for the apparatus 2 to transition to the pointer mode. As illustrated in FIG. 13A, the user lets the apparatus 2 capture images of the palm of a hand of the user. If the gesture recognition unit 18 recognizes this gesture operation based on the range image data from the range image sensor 460, the layer control unit 17 causes transition to the gesture recognition mode. That is, if the palm of a hand of the user is recognized in the initial state, the layer control unit 17 identifies the top layer (e.g., the gesture recognition mode), and the gesture recognition unit 18 becomes ready to recognize the first gesture operation in the top layer.

If the user then swings the palm of the hand upward, as illustrated in FIG. 13B, the range image sensor 460 captures still or video images of this gesture operation. The gesture recognition unit 18 analyzes the range image data and recognizes the gesture operation for transitioning to the pointer mode. Thereby, the layer control unit 17 causes transition to the pointer mode.

FIG. 14 illustrates the gesture operation of pointing the forefinger performed by the user in the pointer mode. If the user points the forefinger at the apparatus 2, the range image sensor 460 captures still or video images of this gesture operation. The gesture recognition unit 18 analyzes the range image data and detects that the forefinger has been pointed at the display 3.

In response to detection that the forefinger has been pointed at the display 3 in the pointer mode, the pointed position detection unit 16 calculates the pointed coordinates on the display 3 with the image data input from the right finger image capturing camera 471 and the left finger image capturing camera 472. The display control unit 13 displays a pointer 51 at the calculated coordinates. The pointed position detection unit 16 calculates the coordinates periodically (e.g., 30 times per second). If the user moves the forefinger in this state, therefore, the pointed coordinates change, and the display control unit 13 moves the pointer 51 to follow the coordinates. As described above, if the gesture recognition unit 18 recognizes the gesture operation of swinging the palm of a hand upward in the top layer (e.g., the gesture recognition mode), the layer control unit 17 causes transition to the pointer mode in the second layer from the top layer. Then, the pointer 51 is displayed at the coordinates on the display 3 detected by the pointed position detection unit 16.

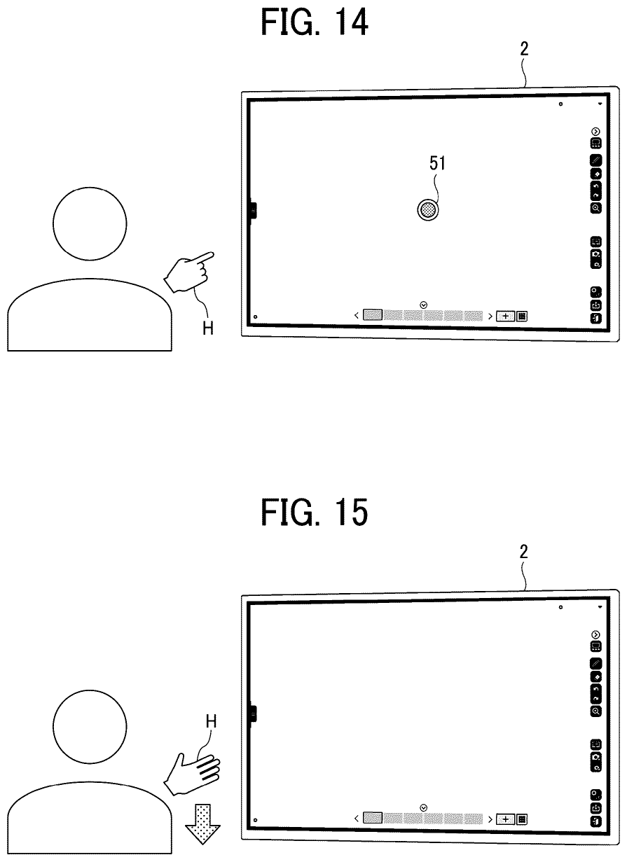

FIG. 15 illustrates the gesture operation for ending the pointer mode performed by the user in the pointer mode. If the user swings the palm of a hand downward, the range image sensor 460 captures still or video images of this gesture operation. The gesture recognition unit 18 analyzes the range image data and recognizes the gesture operation for ending the pointer mode. Thereby, the layer control unit 17 ends the pointer mode. With the pointer mode ended, the display control unit 13 hides the pointer 51, if the pointer 51 has been displayed. The layer control unit 17 causes transition to the gesture recognition mode.

A process flow from the start to the end of the pointer mode will be described.

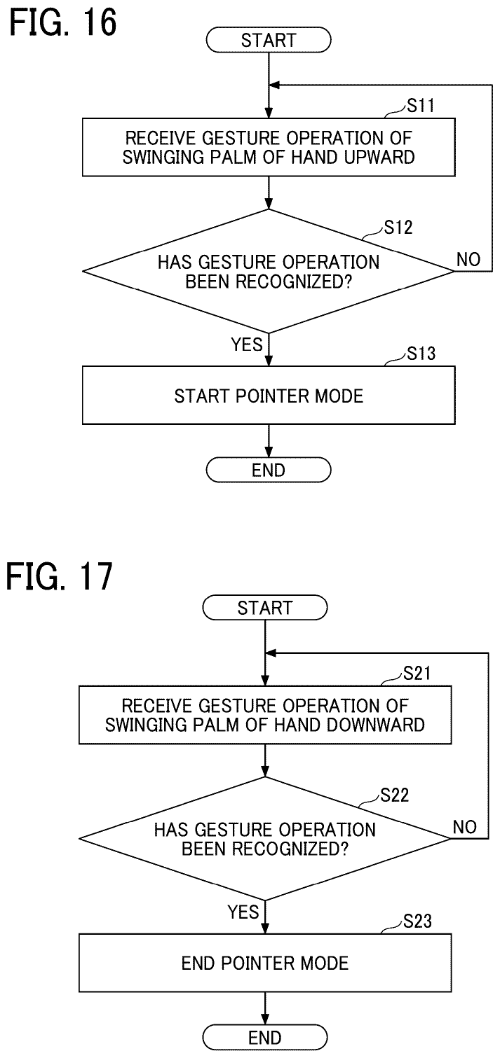

FIG. 16 is a flowchart illustrating a process in which the user causes the apparatus 2 to transition to the pointer mode with a gesture operation. At the beginning of the process in FIG. 16, the apparatus 2 is in the gesture recognition mode, having recognized the palm of a hand.

At step S11, the apparatus 2 receives from the user the gesture operation of swinging the palm of a hand upward. At step S12, the gesture recognition unit 18 analyzes the range image data from the range image sensor 460, and determines whether the gesture operation of swinging the palm of a hand upward has been recognized.

If the gesture recognition unit 18 recognizes this gesture operation (YES at step S12), the layer control unit 17 causes transition to the pointer mode at step S13.

In FIG. 16, swinging the palm of a hand upward is the gesture operation for starting the pointer mode. The gesture operation for starting the pointer mode, however, may be any gesture operation readily performed by the user with a hand. For example, the gesture operation may be swinging the palm of a hand downward, opening or closing five fingers, or turning the palm of a hand.

FIG. 17 is a flowchart illustrating a process in which the user ends the pointer mode with a gesture operation. In the process of FIG. 17, the apparatus 2 is in the pointer mode.

At step S21, the apparatus 2 in the pointer mode receives from the user the gesture operation of swinging the palm of a hand downward. At step S22, the gesture recognition unit 18 analyzes the range image data from the range image sensor 460, and determines whether the gesture operation of swinging the palm of a hand downward has been recognized.

If the gesture recognition unit 18 recognizes this gesture operation (YES at step S22), the layer control unit 17 ends the pointer mode at step S23. If the gesture recognition unit 18 recognizes, in the second layer (e.g., the pointer mode), the gesture operation for ending the recognition of a gesture operation classified in the second layer, the gesture recognition unit 18 becomes ready to recognize a gesture operation classified in the top layer (e.g., the gesture recognition mode).

In FIG. 17, swinging the palm of a hand downward is the gesture operation for ending the pointer mode. The gesture operation for ending the pointer mode, however, may be any gesture operation readily performed by the user with a hand. For example, the gesture operation may be closing the forefinger, stretching the forefinger and the little finger, or stretching the little finger.

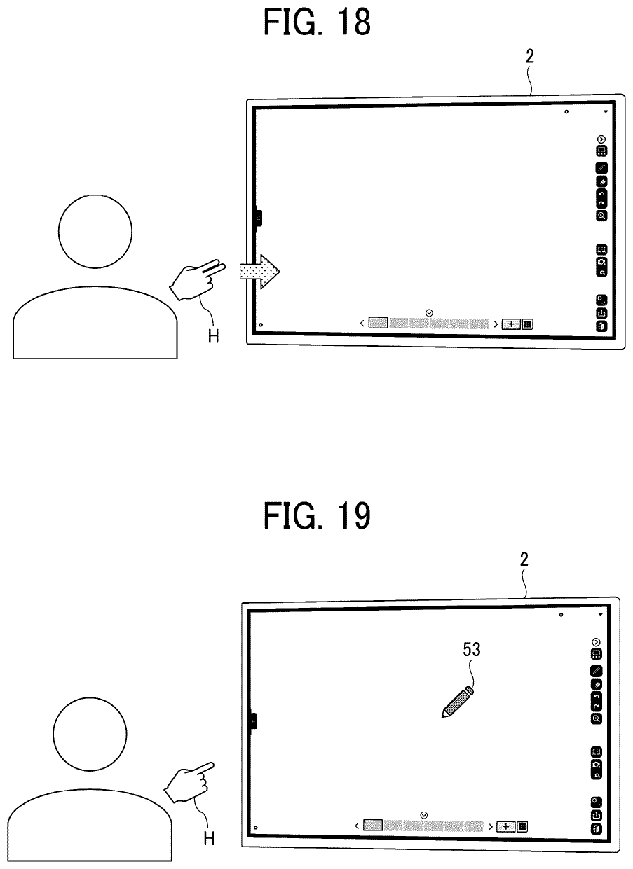

Gesture operations performed from the start to the end of the pen mode will be described with reference to FIG. 18 and other drawings.

FIG. 18 illustrates a gesture operation for the apparatus 2 to transition to the pen mode. If the user points two fingers at the apparatus 2, the range image sensor 460 captures still or video images of this gesture operation. The gesture recognition unit 18 analyzes the range image data and detects that two fingers have been swung horizontally. Thereby, the layer control unit 17 causes transition to the pen mode.

FIG. 19 illustrates a gesture operation for the apparatus 2 to display a pen icon 53 in the pen mode. If the user points the forefinger at the apparatus 2, the range image sensor 460 captures still or video images of this gesture operation. The gesture recognition unit 18 analyzes the range image data and detects that the forefinger has been pointed at the display 3.

In response to detection that the forefinger has been pointed at the display 3 in the pen mode, the pointed position detection unit 16 calculates the pointed coordinates with the image data input from the right finger image capturing camera 471 and the left finger image capturing camera 472. The display control unit 13 displays the pen icon 53 at the calculated coordinates. If the user moves the forefinger in this state, the display control unit 13 moves the pen icon 53 to follow the pointed coordinates.

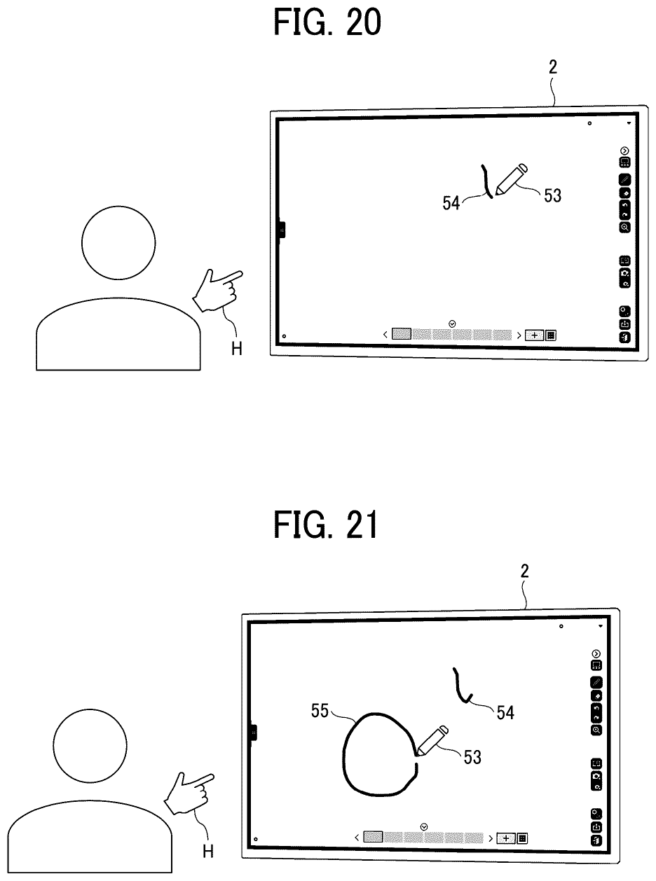

FIG. 20 illustrates a gesture operation for the apparatus 2 to draw a line in the pen mode. If the user stretches the thumb with the forefinger stretched, the range image sensor 460 captures still or video images of this gesture operation. The gesture recognition unit 18 analyzes the range image data and recognizes the gesture operation of stretching the thumb with the forefinger stretched. The display control unit 13 performs pen-down at the coordinates at which the pen icon 53 is displayed. Preferably, the display control unit 13 changes the color or shape of the pen icon 53 to indicate that the virtual pen is in contact with the display 3. In FIG. 20, the color of the pen icon 53 has been changed. With the pen-down, the apparatus 2 starts drawing. If the user moves the forefinger with the thumb stretched, the writing/drawing data generation unit 12 generates a drawn line 54 based on the trajectory of the pointed coordinates, and the display control unit 13 displays the drawn line 54.

As described above, if the gesture recognition unit 18 recognizes, in the pen mode, the gesture operation of stretching the thumb with forefinger pointing at the apparatus 2, the gesture recognition unit 18 identifies the pen-down mode. Then, the display control unit 13 displays the pen icon 53 in a style different from a style used before the pen-down mode.

FIG. 21 illustrates a gesture operation for the apparatus 2 to draw a line again in the pen mode. If the user closes the thumb, the range image sensor 460 captures still or video images of this gesture operation. The gesture recognition unit 18 analyzes the range image data and recognizes the gesture operation for pen-up.

If the user moves the forefinger, the display control unit 13 moves the pen icon 53 to follow the pointed coordinates. If the user then stretches the thumb with the forefinger pointing at the apparatus 2, the gesture recognition unit 18 recognizes the gesture operation of stretching the thumb, and the apparatus 2 transitions to the pen-down mode. If the user moves the forefinger with the thumb stretched, the writing/drawing data generation unit 12 generates a drawn line 55 based on the trajectory of the pointed coordinates, and the display control unit 13 displays the drawn line 55. The user thus draws a line again by changing the position of the pen icon 53.

If the user then closes the forefinger, the range image sensor 460 captures still or video images of this gesture operation. The gesture recognition unit 18 analyzes the range image data and recognizes the gesture operation for ending the pen mode. The layer control unit 17 ends the pen mode to transition to the pointer mode.

In the pen mode, the user may press a menu button. In the pen-up mode, the user may move the pen icon 53 to a menu button and stretch the thumb. Thereby, the receiving unit 14 receives the pressing of the menu button. The user thus selects the color, width, or type of the drawn line, for example. The display control unit 13 does not display the drawn line in an area overlapping the menu button.

A process flow from the start to the end of the pen mode will be described.

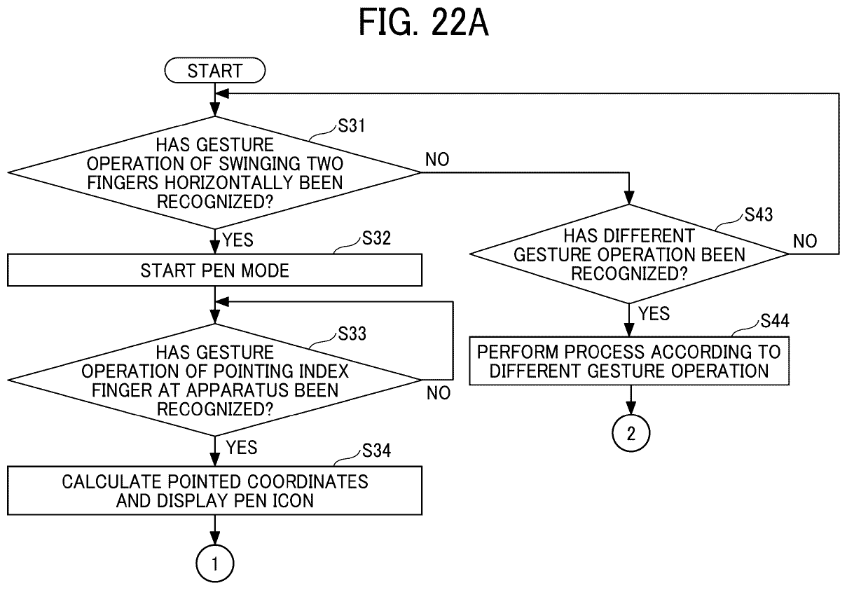

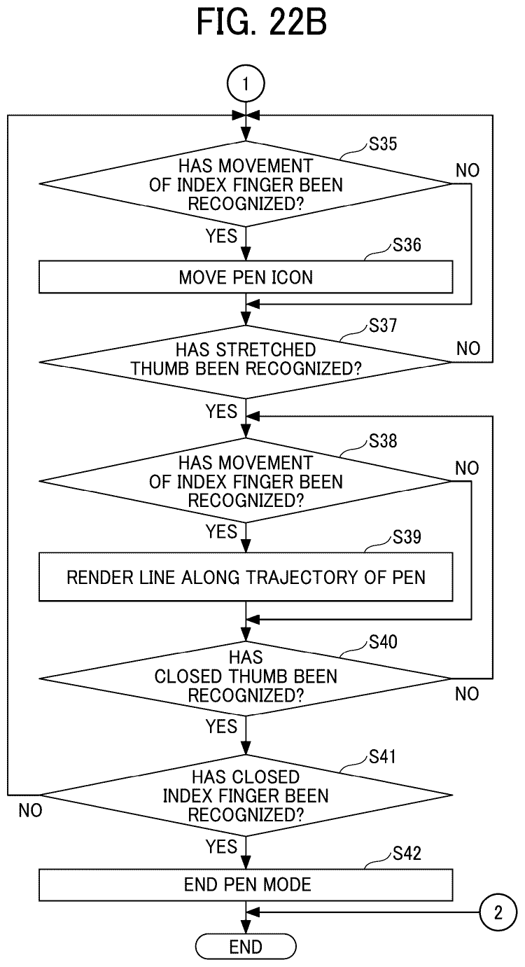

FIGS. 22A and 22B (FIG. 22) are a flowchart illustrating a process in which the user causes the apparatus 2 to transition to the pen mode and end the pen mode with gesture operations. At the beginning of the process in FIGS. 22A and 22B, the apparatus 2 is in the pointer mode, having recognized the gesture operation of swinging the palm of a hand upward.

A t step S31, the gesture recognition unit 18 analyzes the range image data from the range image sensor 460, and determines whether the gesture operation of swinging two fingers horizontally has been recognized. If YES at step S31, the process proceeds to step S32. If NO at step S31, the process proceeds to step S43.

At step S32, the layer control unit 17 causes transition to the pen mode.

At step S33, the gesture recognition unit 18 analyzes the range image data from the range image sensor 460, and determines whether the gesture operation of pointing the forefinger at the display 3 of the apparatus 2 has been recognized. If YES at step S33, the process proceeds to step S34. If NO at step S33, the process repeats step S33.

At step S34, the pointed position detection unit 16 calculates the coordinates pointed by the forefinger, and the display control unit 13 displays the pen icon 53 at the coordinates.

At step S35, the pointed position detection unit 16 determines whether movement of the forefinger has been detected based on the coordinates pointed by the forefinger. If YES at step S35, the process proceeds to step S36. If NO at step S35, the process proceeds to step S37.

At step S36, the display control unit 13 moves the pen icon 53 to the coordinates pointed by the forefinger and calculated by the pointed position detection unit 16.

At step S37, the gesture recognition unit 18 analyzes the range image data from the range image sensor 460, and determines whether the gesture operation of stretching the thumb with the forefinger pointing at the display 3 of the apparatus 2 has been recognized. If YES at step S37, the process proceeds to step S38. If NO at step S37, the process returns to step S35.

At step S38, the gesture recognition unit 18 recognizes the pen-down mode in the pen mode, and the pointed position detection unit 16 determines whether movement of the forefinger has been detected based on the coordinates pointed by the forefinger. If YES at step S38, the process proceeds to step S39. If NO at step S38, the process proceeds to step S40.

At step S39, the writing/drawing data generation unit 12 generates a drawn line based on the trajectory of the coordinates pointed by the forefinger and calculated by the pointed position detection unit 16, and the display control unit 13 displays the drawn line.

At step S40, the gesture recognition unit 18 analyzes the range image data from the range image sensor 460, and determines whether the gesture operation of closing the thumb has been recognized. If YES at step S40, the process proceeds to step S41. If NO at step S40, the process returns to step S38.

At step S41, the gesture recognition unit 18 analyzes the range image data from the range image sensor 460, and determines whether the gesture operation of closing the forefinger has been recognized. If YES at step S41, the process proceeds to step S42. If NO at step S41, the process returns to step S35.

At step S42, with the gesture operation of closing the forefinger having been recognized, the layer control unit 17 ends the pen mode. The pen mode transitions to the pointer mode. If the gesture recognition unit 18 recognizes, in the third layer (e.g., the pen mode), the gesture operation for ending the recognition of a gesture operation classified in the third layer, the gesture recognition unit 18 becomes ready to recognize a gesture operation classified in the second layer (e.g., the pointer mode). The gesture operation for ending the pen mode is the same as the gesture operation for ending the marker mode and the gesture operation for ending the eraser mode. Thereby, the number of gesture operations for the user to memorize is reduced.

At step S43, the gesture recognition unit 18 analyzes the range image data from the range image sensor 460, and determines whether a different gesture operation has been recognized. Herein, the different gesture operation is the gesture operation of swinging three fingers horizontally, swinging three fingers vertically, swinging four fingers to the left, or swinging four fingers to the right. If YES at step S43, the process proceeds to step S44. If NO at step S43, the process returns to step S31.

At step S44, the gesture recognition unit 18 performs a process according to the different gesture operation.

In FIGS. 22A and 22B, swinging two fingers horizontally is the gesture operation for starting the pen mode. The gesture operation for starting the pen mode, however, may be any gesture operation readily performed by the user with a hand. For example, the gesture operation may be swinging two fingers vertically, swinging three fingers horizontally, or swinging three fingers vertically.

In FIGS. 22A and 22B, closing the forefinger is the gesture operation for ending the pen mode. The gesture operation for ending the pen mode, however, may be any gesture operation readily performed by the user with a hand. For example, the gesture operation may be stretching the forefinger and the little finger or stretching the little finger.

Pressing a menu button in the pen mode will be described. Specifically, a gesture operation performed by the user in the pen mode to put the pen down, draw a line, lift the pen up, and change the color of the drawn line will be described.

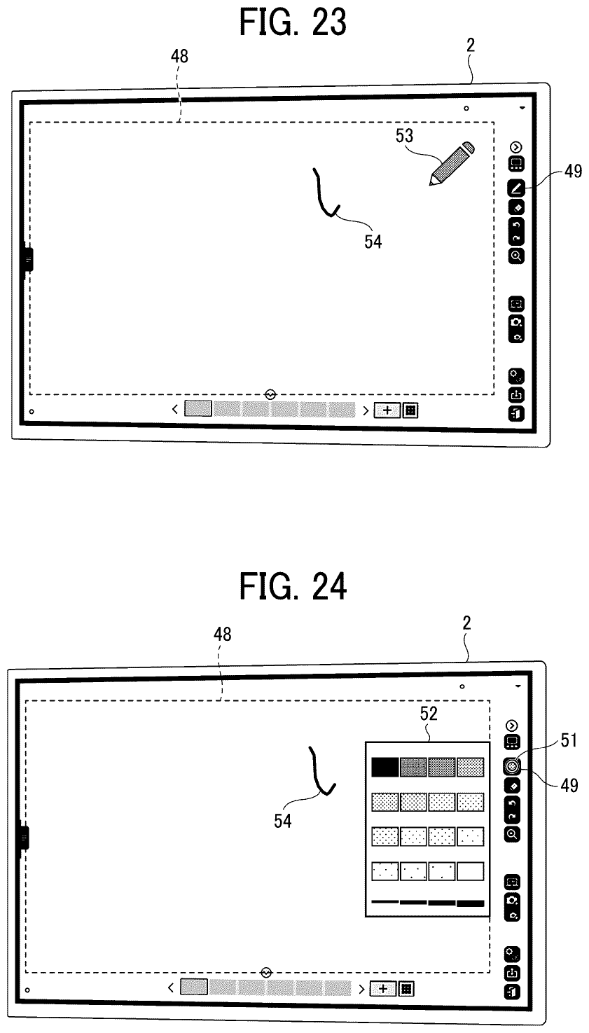

FIG. 23 is a diagram illustrating a writable/drawable area and menu buttons. A writable/drawable area 48 in which the user inputs handwriting or hand drawing is previously set in the display area of the display 3 of the apparatus 2. If the coordinates pointed by the user with the forefinger are inside the writable/drawable area 48, the apparatus 2 displays the drawn line along the trajectory of the coordinates. If the coordinates are outside the writable/drawable area 48, the apparatus 2 does not display the drawn line.

Menu buttons for receiving various settings are displayed at the right end of the display 3. If the user hand-draws a line in the pen mode, closes the thumb to transition to the pen-up mode, and moves the coordinates pointed by the forefinger to the outside of the writable/drawable area 48, the display control unit 13 displays the pen icon 53 at the coordinates. If the user then moves the coordinates pointed by the forefinger (i.e., a pointer display position) to a pen setting button and stretches the thumb, the gesture recognition unit 18 recognizes the gesture operation of stretching the thumb. Since the coordinates are outside the writable/drawable area 48, the display control unit 13 does not display the drawn line. The display control unit 13 may change the pen icon 53 to the pointer 51. The whiteboard control unit 15 determines that the coordinates of the pen-down position correspond to the position of a menu button, and that the menu button has been selected. In this example, the pressed menu button is a menu button 49 for selecting the color and width of the pen-drawn line. This process is similar to a process for the touch panel to detect a touch. The whiteboard control unit 15 then displays a selection menu for selecting the color and width of the pen-drawn line.

FIG. 24 illustrates a selection menu 52 displayed on the display 3. If the user closes the thumb to transition to the pen-up mode, moves the coordinates pointed by the forefinger (i.e., the position indicated by the pointer 51) onto a color in the selection menu 52 that is desired to be set, and stretches the thumb, the gesture recognition unit 18 recognizes the gesture operation of stretching the thumb. The whiteboard control unit 15 identifies the color displayed at the coordinates pointed by the forefinger with the thumb stretched, and determines that the identified color has been selected. The display control unit 13 then hides the selection menu 52. If the user then moves the coordinates pointed by the forefinger to a pen-down position and stretches the thumb, the gesture recognition unit 18 recognizes this gesture operation, and the display control unit 13 displays the pen icon 53 in the style for the pen-down mode. If the user moves the forefinger in the pen-down mode, the display control unit 13 displays a drawn line in the selected color along the trajectory of the coordinates pointed by the forefinger. The user thus changes the settings such as the color and width of the drawn line while retaining the pen mode.

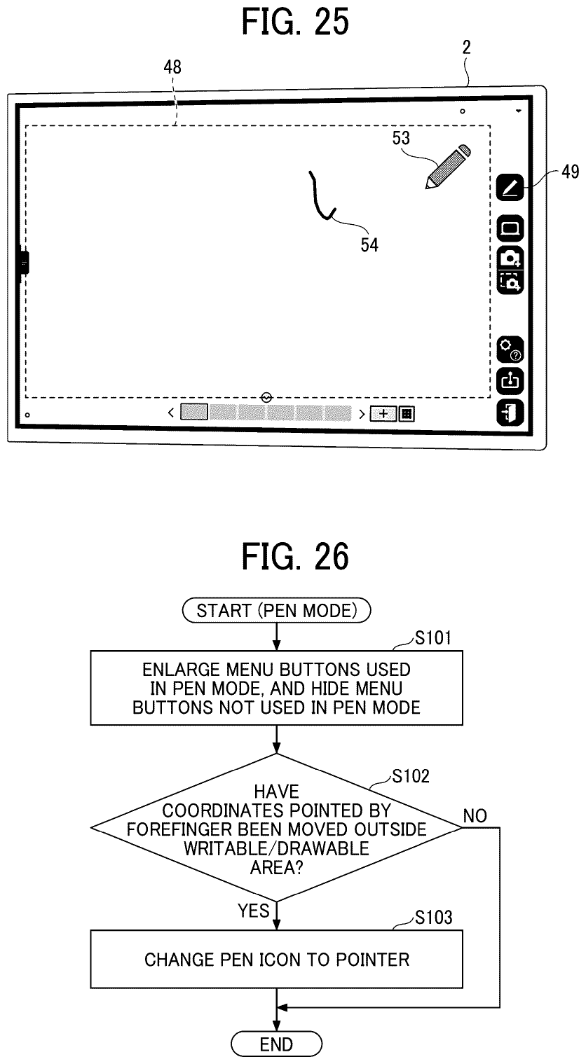

When the pen mode is turned on with the gesture operation, the display control unit 13 may increase the sizes of some of the menu buttons and hide the other menu buttons not used in the pen mode. FIG. 25 illustrates a display example of this case.

FIG. 25 illustrates a display example of the menu buttons in the pen mode. In FIG. 25, the menu button 49 for selecting the color and width of the pen-drawn line is enlarged, while the menu buttons not used in the pen mode are hidden. Thereby, the user can readily point the menu button 49 with the forefinger, and is less likely to unintentionally select a wrong menu button.

FIG. 26 is a flowchart illustrating a method of operating the menu buttons in the pen mode. The process of FIG. 26 starts when the pen mode is turned on.

At step S101, with the pen mode turned on, the display control unit 13 enlarges the menu buttons used in the pen mode and hides the menu buttons not used in the pen mode.

At step S102, based on the coordinates pointed by the forefinger and detected by the pointed position detection unit 16, the whiteboard control unit 15 determines whether the coordinates have been moved outside the writable/drawable area 48.

If the coordinates pointed by the forefinger and detected by the pointed position detection unit 16 are outside the writable/drawable area 48 (YES at step S102), the display control unit 13 changes the pen icon 53 to the pointer 51 at step S103. If the coordinates pointed by the forefinger and detected by the pointed position detection unit 16 are inside the writable/drawable area 48 (NO at step S102), the display control unit 13 continues to display the pen icon 53.

Gesture operations performed from the start to the end of the marker mode will be described with reference to FIG. 27 and other drawings.

FIG. 27 illustrates a gesture operation for the apparatus 2 to transition to the marker mode. If the user points three fingers at the apparatus 2 and swings the three fingers horizontally, the range image sensor 460 captures still or video images of this gesture operation. The gesture recognition unit 18 analyzes the range image data and detects that three fingers have been swung horizontally. Thereby, the layer control unit 17 causes transition to the marker mode.

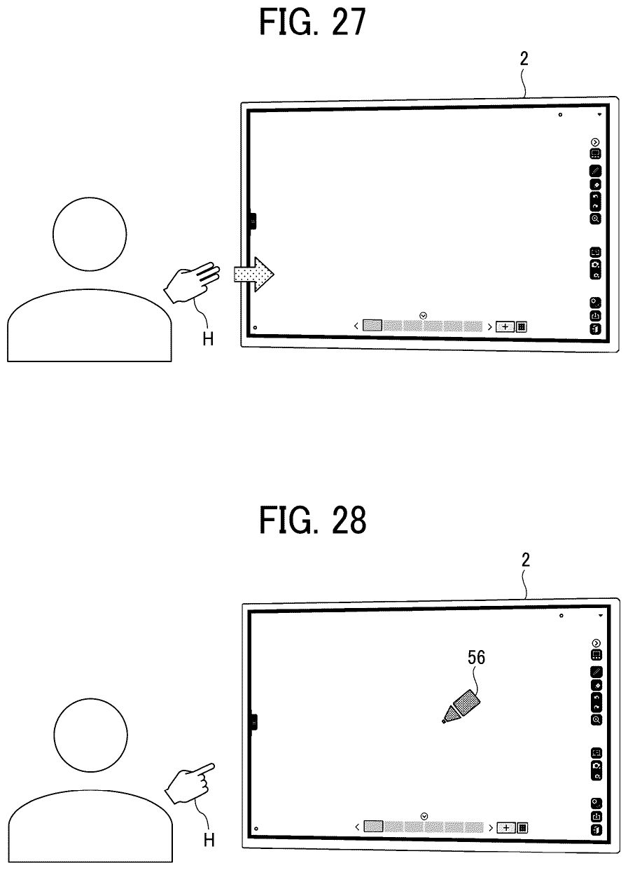

FIG. 28 illustrates a gesture operation for the apparatus 2 to display a marker icon 56 in the marker mode. If the user points the forefinger at the apparatus 2, the range image sensor 460 captures still or video images of this gesture operation. The gesture recognition unit 18 analyzes the range image data and recognizes that the forefinger has been pointed at the display 3.

In response to detection that the forefinger has been pointed at the display 3 in the marker mode, the pointed position detection unit 16 calculates the pointed coordinates with the image data input from the right finger image capturing camera 471 and the left finger image capturing camera 472. The display control unit 13 displays the marker icon 56 at the coordinates. Then, if the user moves the forefinger in the marker mode, the display control unit 13 moves the marker icon 56 to follow the pointed coordinates.

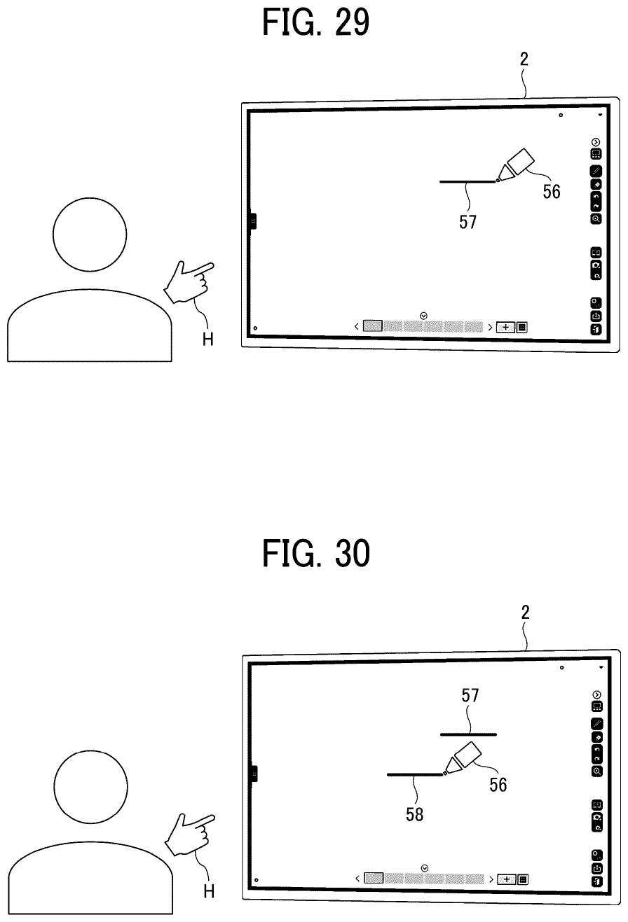

FIG. 29 illustrates a gesture operation for the apparatus 2 to draw a line in the marker mode. If the user stretches the thumb with the forefinger stretched, the range image sensor 460 captures still or video images of this gesture operation. The gesture recognition unit 18 analyzes the range image data and recognizes the gesture operation of stretching the thumb (i.e., transition to the pen-down mode within the marker mode). The display control unit 13 performs pen-down at the coordinates at which the marker icon 56 is displayed. Preferably, the display control unit 13 changes the color or shape of the marker icon 56 to indicate that the virtual marker is in contact with the display 3. In FIG. 29, the color of the marker icon 56 has been changed. The apparatus 2 starts drawing a marker line. If the user moves the forefinger in the pen-down mode, the writing/drawing data generation unit 12 generates a marker line 57 based on the trajectory of the pointed coordinates, and the display control unit 13 displays the marker line 57.

As described above, if the gesture recognition unit 18 recognizes the gesture operation of stretching the thumb with the forefinger pointing at the apparatus 2 in the marker mode, the gesture recognition unit 18 identifies the pen-down mode. Then, the display control unit 13 displays the marker icon 56 in a style different from a style used before the pen-down mode.

FIG. 30 illustrates a gesture operation for the apparatus 2 to draw a line again in the marker mode. If the user closes the thumb, the range image sensor 460 captures still or video images of this gesture operation. The gesture recognition unit 18 analyzes the range image data and recognizes the gesture operation for pen-up.

If the user moves the forefinger, the display control unit 13 moves the marker icon 56 to follow the pointed coordinates. If the user then stretches the thumb with the forefinger pointing at the apparatus 2, the gesture recognition unit 18 recognizes the gesture operation of stretching the thumb, and the apparatus 2 transitions to the pen-down mode. If the user moves the forefinger in the pen-down mode, the writing/drawing data generation unit 12 generates a marker line 58 based on the trajectory of the pointed coordinates, and the display control unit 13 displays the marker line 58. The user thus draws a line again by changing the position of the marker icon 56.

If the user closes the forefinger, the range image sensor 460 captures still or video images of this gesture operation. The gesture recognition unit 18 analyzes the range image data and recognizes the gesture operation for ending the marker mode. The layer control unit 17 ends the marker mode to transition to the pointer mode.

In the marker mode, the user may press a menu button. In the pen-up mode, the user may move the marker icon 56 to a menu icon and stretch the thumb. Thereby, the receiving unit 14 receives the pressing of the menu button. The user thus selects the color, width, or type of the marker line, for example. The display control unit 13 does not display the marker line in an area overlapping the menu button.

A flowchart illustrating the recognition of gesture operations in the marker mode is similar to that of FIGS. 22A and 22B except for the different number of fingers used to transition to the marker mode.

In the first embodiment, swinging three fingers horizontally is the gesture operation for starting the marker mode. The gesture operation for starting the marker mode, however, may be any gesture operation readily performed by the user with a hand. For example, the gesture operation may be swinging two fingers horizontally, swinging two fingers vertically, or swinging three fingers vertically.

Further, in the first embodiment, closing the forefinger is the gesture operation for ending the marker mode. The gesture operation for ending the marker mode, however, may be any gesture operation readily performed by the user with a hand. For example, the gesture operation may be stretching the forefinger and the little finger or stretching the little finger.

In the marker mode, the display control unit 13 may preferably enlarge the menu buttons used in the marker mode and hide the menu buttons not used in the marker mode, similarly as in the pen mode illustrated in FIGS. 23 to 26.

Gesture operations performed from the start to the end of the eraser mode will be described.

FIG. 31 illustrates a gesture operation for the apparatus 2 to transition to the eraser mode. If the user points three fingers at the apparatus 2 and swings the three fingers vertically, the range image sensor 460 captures still or video images of this gesture operation. The gesture recognition unit 18 analyzes the range image data and detects that three fingers have been swung vertically. Thereby, the layer control unit 17 causes transition to the eraser mode.

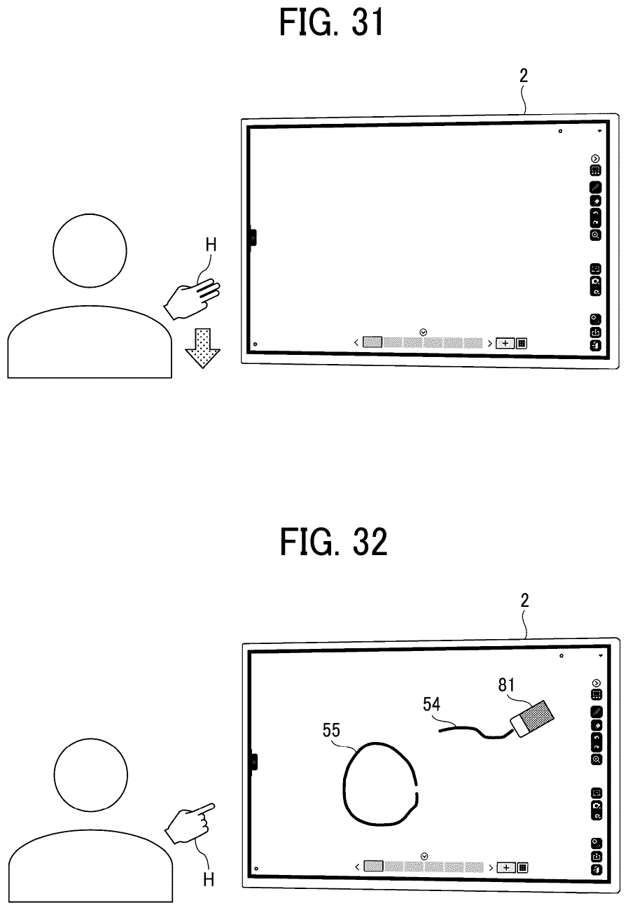

FIG. 32 illustrates a gesture operation for the apparatus 2 to display an eraser icon 81 in the eraser mode. If the user points the forefinger at the apparatus 2 in the eraser mode, the range image sensor 460 captures still or video images of this gesture operation. The gesture recognition unit 18 analyzes the range image data and detects that the forefinger has been pointed at the display 3.

In response to detection that the forefinger has been pointed at the display 3, the pointed position detection unit 16 calculates the pointed coordinates with the image data input from the right finger image capturing camera 471 and the left finger image capturing camera 472. The display control unit 13 displays the eraser icon 81 at the pointed coordinates. If the user moves the forefinger in this state, the display control unit 13 moves the eraser icon 81 to follow the pointed coordinates.

FIG. 33 illustrates a gesture operation for the apparatus 2 to erase the drawn line 55 in the eraser mode. If the user stretches the thumb with the forefinger stretched, the range image sensor 460 captures still or video images of this gesture operation. The gesture recognition unit 18 analyzes the range image data and recognizes the gesture operation of stretching the thumb. The gesture recognition unit 18 recognizes that the virtual eraser is in contact with the display 3 (i.e., transition within the eraser mode to the mode in which the virtual eraser is in contact with the display 3). The display control unit 13 may preferably change the color or shape of the eraser icon 81 to indicate that the virtual eraser is in contact with the display 3. In FIG. 33, the color of the eraser icon 81 has been changed. If the user moves the forefinger in the mode in which the virtual eraser is in contact with the display 3, the display control unit 13 erases the drawn line 54 in FIG. 32 drawn at the pointed coordinates.

A s described above, if the gesture recognition unit 18 recognizes the gesture operation of stretching the thumb with the forefinger pointing at the apparatus 2 in the eraser mode, the gesture recognition unit 18 determines that the virtual eraser has been brought into contact with the display 3. Then, the display control unit 13 displays the eraser icon 81 in a style different from a style used before the contact of the virtual eraser with the display 3.

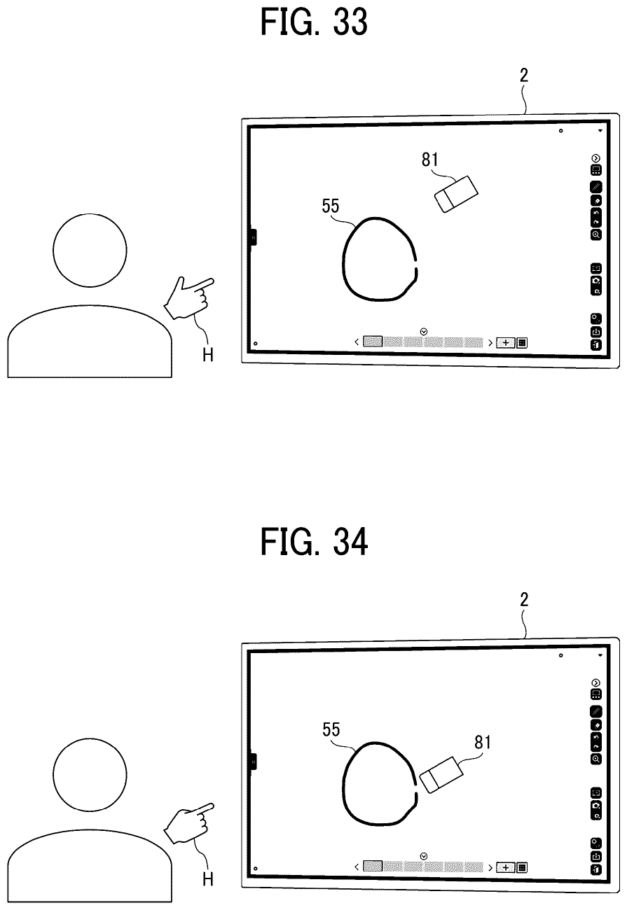

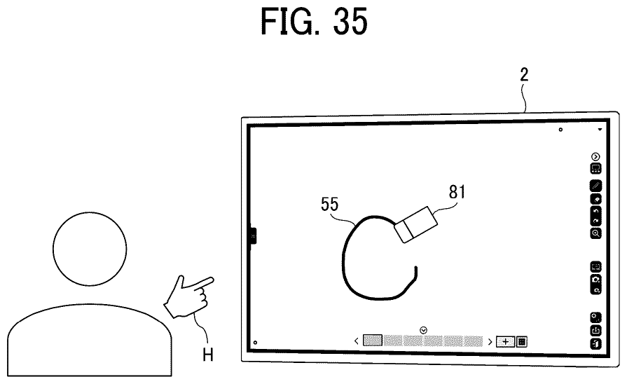

FIGS. 34 and 35 illustrate gesture operations for the apparatus 2 to erase the different drawn line 55 in the eraser mode. If the user closes the thumb, the range image sensor 460 captures still or video images of this gesture operation. The gesture recognition unit 18 analyzes the range image data and recognizes a gesture operation for releasing the virtual eraser from the display 3.

If the user moves the forefinger, the display control unit 13 moves the eraser icon 81 to follow the pointed coordinates. If the user then stretches the thumb with the forefinger pointing at the apparatus 2, the gesture recognition unit 18 recognizes that the virtual eraser is in contact with the display 3 (i.e., transition to the mode in which the virtual eraser is in contact with the display 3). The display control unit 13 may preferably change the color or shape of the eraser icon 81 to indicate that the virtual eraser is in contact with the display 3. If the user moves the forefinger in the mode in which the virtual eraser is in contact with the display 3, the display control unit 13 erases the drawn line 55 drawn at the pointed coordinates. The user thus erases the drawn line again by changing the position of the eraser icon 81.

If the user closes the forefinger, the range image sensor 460 captures still or video images of this gesture operation. The gesture recognition unit 18 analyzes the range image data and recognizes the gesture operation for ending the eraser mode, and the layer control unit 17 ends the eraser mode.

A process flow from the start to the end of the eraser mode will be described.

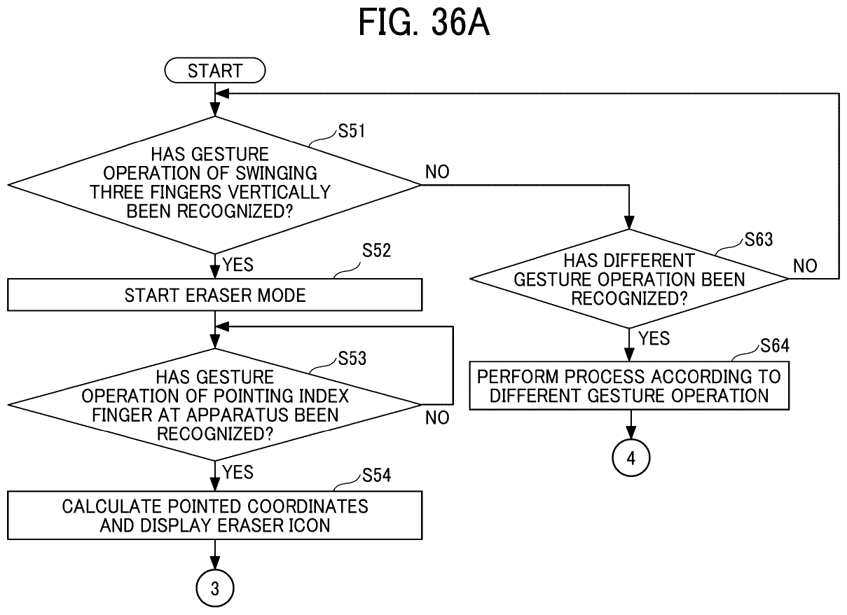

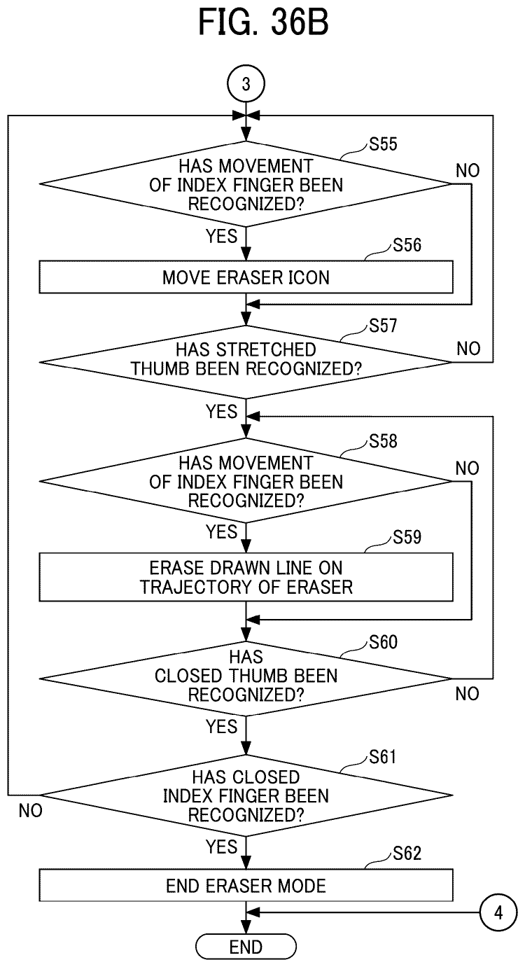

FIGS. 36A and 36B (FIG. 36) are a flowchart illustrating a process in which the user causes the apparatus 2 to transition to the eraser mode and end the eraser mode with gesture operations. At the beginning of the process in FIGS. 36A and 36B, the apparatus 2 is in the pointer mode.

At step S51, the gesture recognition unit 18 analyzes the range image data from the range image sensor 460, and determines whether the gesture operation of swinging three fingers vertically has been recognized. If YES at step S51, the process proceeds to step S52. If NO at step S51, the process proceeds to step S63.

At step S52, the layer control unit 17 causes transition to the eraser mode.

At step S53, the gesture recognition unit 18 analyzes the range image data from the range image sensor 460, and determines whether the gesture operation of pointing the forefinger at the display 3 of the apparatus 2 has been recognized. If YES at step S53, the process proceeds to step S54. If NO at step S53, the process repeats step S53.

At step S54, the pointed position detection unit 16 calculates the coordinates pointed by the forefinger, and the display control unit 13 displays the eraser icon 81 at the coordinates.

At step S55, the pointed position detection unit 16 determines whether movement of the forefinger has been detected based on the coordinates pointed by the forefinger. If YES at step S55, the process proceeds to step S56. If NO at step S55, the process proceeds to step S57.

At step S56, the display control unit 13 moves the eraser icon 81 to the coordinates pointed by the forefinger and calculated by the pointed position detection unit 16.

At step S57, the gesture recognition unit 18 analyzes the range image data from the range image sensor 460, and determines whether the gesture operation of stretching the thumb with the forefinger pointing at the display 3 has been recognized. If YES at step S57, the process proceeds to step S58. If NO at step S57, the process returns to step S55.

At step S58, the gesture recognition unit 18 recognizes the mode in which the virtual eraser is in contact with the touch panel. The pointed position detection unit 16 determines whether movement of the forefinger has been detected based on the coordinates pointed by the forefinger. If YES at step S58, the process proceeds to step S59. If NO at step S58, the process proceeds to step S60.

At step S59, the display control unit 13 erases the drawn line present at the trajectory of the coordinates pointed by the forefinger and calculated by the pointed position detection unit 16.

At step S60, the gesture recognition unit 18 analyzes the range image data from the range image sensor 460, and determines whether the gesture operation of closing the thumb has been recognized. If YES at step S60, the process proceeds to step S61. If NO at step S60, the process returns to step S58.

At step S61, the gesture recognition unit 18 recognizes the mode in which the virtual eraser is separate from the touch panel. The gesture recognition unit 18 analyzes the range image data from the range image sensor 460, and determines whether the gesture operation of closing the forefinger has been recognized. If YES at step S61, the process proceeds to step S62. If NO at step S61, the process returns to step S55.

At step S62, with the gesture operation of closing the forefinger having been recognized, the layer control unit 17 ends the eraser mode. The eraser mode transitions to the pointer mode.

At step S63, the gesture recognition unit 18 analyzes the range image data from the range image sensor 460, and determines whether a different gesture operation has been recognized. Herein, the different gesture operation is swinging two fingers horizontally, swinging three fingers horizontally, swinging four fingers to the left, or swinging four fingers to the right. If YES at step S63, the process proceeds to step S64. If NO at step S63, the process returns to step S51.

At step S64, the gesture recognition unit 18 performs a process according to the different gesture operation.

In FIGS. 36A and 36B, swinging three fingers vertically is the gesture operation for starting the eraser mode. The gesture operation for starting the eraser mode, however, may be any gesture operation readily performed by the user with a hand. For example, the gesture operation may be swinging two fingers horizontally, swinging two fingers vertically, or swinging three fingers horizontally.

In FIGS. 36A and 36B, closing the forefinger is the gesture operation for ending the eraser mode. The gesture operation for ending the eraser mode, however, may be any gesture operation readily performed by the user with a hand. For example, the gesture operation may be stretching the forefinger and the little finger or stretching the little finger.

In the eraser mode, the display control unit 13 may preferably enlarge the menu buttons used in the eraser mode and hide the menu buttons not used in the eraser mode, similarly as in the pen mode illustrated in FIGS. 23 to 26.

As described above, the gesture recognition unit 18 recognizes, from an identical gesture operation, the gesture operation for pen-down in the pen mode, the gesture operation for pen-down in the marker mode, and the gesture operation for bringing the virtual eraser into contact with the display 3 in the eraser mode. The gesture recognition unit 18 further recognizes, from another identical gesture operation, the gesture operation for pen-up in the pen mode, the gesture operation for pen-up in the marker mode, and the gesture operation for releasing the virtual eraser from the display 3 in the eraser mode. Further, the gesture recognition unit 18 recognizes, from yet another identical gesture operation, the gesture operation for ending the pen mode, the gesture operation for ending the marker mode, and the gesture operation for ending the eraser mode.

Page switching will be described.

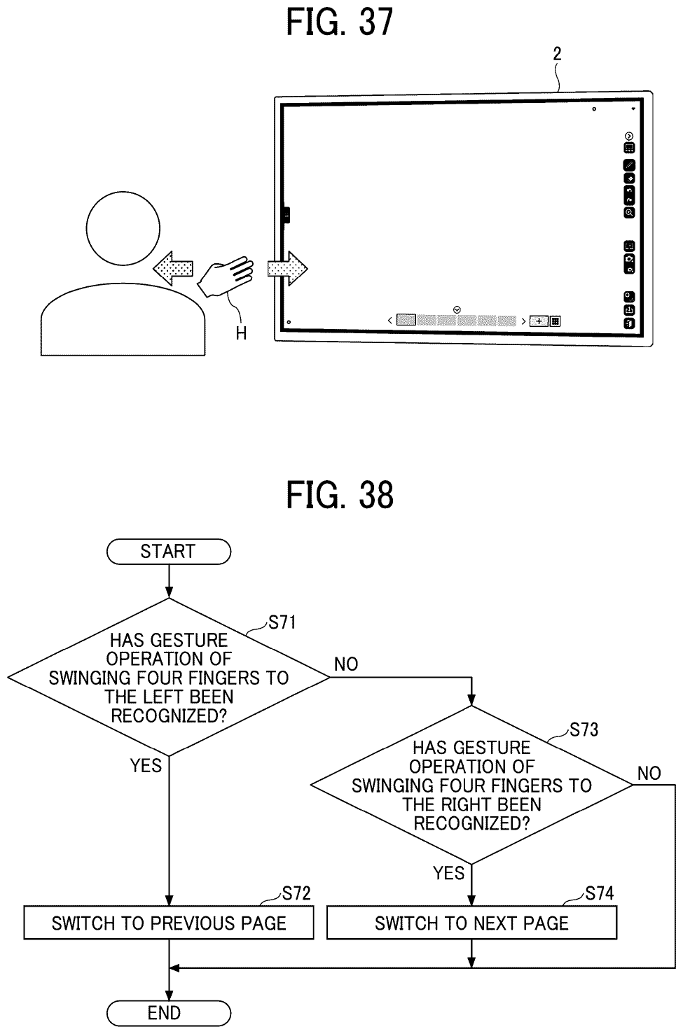

FIG. 37 illustrates a gesture operation for switching the page. If the user points four fingers at the apparatus 2 and swings the four fingers to the left or right, the range image sensor 460 captures still or video images of this gesture operation. The gesture recognition unit 18 analyzes the range image data and detects that four fingers have been swung to the left or right. Thereby, if the four fingers are swung to the left, the receiving unit 14 receives an operation for switching to the previous page. If the four fingers are swung to the right, the receiving unit 14 receives an operation for switching to the next page.

In FIG. 37, swinging four fingers horizontally is the gesture operation for switching the page. The gesture operation for switching the page, however, may be any gesture operation readily performed by the user with a hand. For example, the gesture operation may be swinging two fingers horizontally, swinging two fingers vertically, swinging three fingers horizontally, swinging three fingers vertically, or swinging four fingers vertically.

A process flow to switch the page will be described.

FIG. 38 is a flowchart illustrating a process in which the user switches the page with a gesture operation. The apparatus 2 may be in any of the pointer mode, the pen mode, the marker mode, and the eraser mode.

At step 571, the gesture recognition unit 18 analyzes the range image data from the range image sensor 460, and determines whether the gesture operation of swinging four fingers to the left has been recognized. If YES at step S71, the process proceeds to step S72. If NO at step S71, the process proceeds to step S73.

At step S72, the display control unit 13 switches the currently displayed page to the previous page.

At step S73, the gesture recognition unit 18 analyzes the range image data from the range image sensor 460, and determines whether the gesture operation of swinging four fingers to the right has been recognized. If YES at step S73, the process proceeds to step S74. If NO at step S73, the process of FIG. 38 is completed.

At step S74, the display control unit 13 switches the currently displayed page to the next page.

A typical apparatus involves many gesture operations. For example, if the types of gesture operations correspond one-to-one to the operations received by the apparatus, the number of gesture operations increases with an increase in the number of operations received through the gesture operations. In this case, the user is expected to memorize all of the gesture operations, increasing the time for the user to learn the gesture operations.

The apparatus 2 of the first embodiment recognizes the gesture operations previously set in three layers. With the gesture operations layered, more operations are performed with less gesture operations, obviating the need for the user to memorize many gesture operations. For example, drawing a pen line in the pen mode, drawing a marker line in the marker mode, and erasing a pen-drawn line in the eraser mode are all performed with the forefinger. If the gesture operations are not thus layered, the user is expected to learn three times more gesture operations. The above-described configuration of the apparatus 2 reduces the number of gesture operations.

Further, in the typical apparatus, the types of gesture operations correspond one-to-one to the commands to the apparatus. Therefore, a curved line not assigned with a command, for example, is difficult to draw with a gesture operation. Further, when the user hand-draws a line on the typical apparatus, the user walks up to the apparatus. The apparatus 2 of the first embodiment, on the other hand, has the pen mode, enabling a user in a seated state to draw a red line, for example, on a certain part of what is displayed on the apparatus 2 with gesture operations, obviating the need for the user to walk up to the apparatus 2 to draw the line.

A second embodiment of the present disclosure will be described.

In the apparatus 2 of the second embodiment describe below, each of the layers lower than the first layer includes a plurality of modes, and each of the plurality of modes corresponds to a plurality of gesture operations. That is, in the apparatus 2 of the second embodiment, each of the layers lower than the first layer includes a plurality of modes instead of a single mode, and a plurality of gesture operations are receivable in each of the plurality of modes.

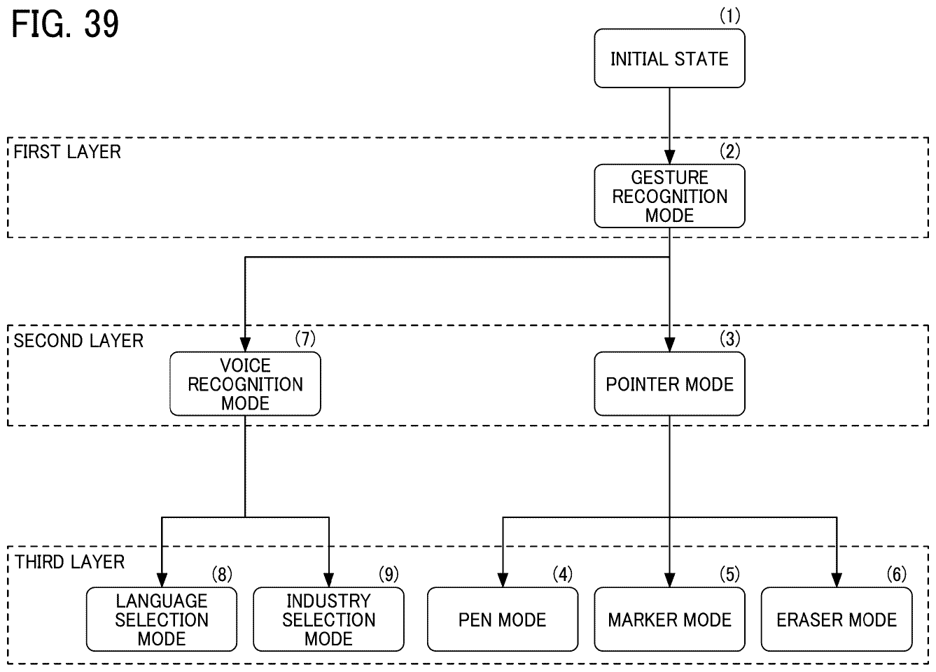

FIG. 39 illustrates an example of layered gesture operations available in the apparatus 2 of the second embodiment. The apparatus 2 has a plurality of modes in each of the layers lower than the first layer. For example, the second layer includes the pointer mode and a voice recognition mode, and the third layer includes the pen mode, the marker mode, the eraser mode, a language selection mode, and an industry selection mode. In FIG. 39, the gesture operation for transitioning from the gesture recognition mode (2) in the first layer to the pointer mode (3), the gesture operation for transitioning from the pointer mode (3) to the pen mode (4), the gesture operation for transitioning from the pointer mode (3) to the marker mode (5), and the gesture operation for transitioning from the pointer mode (3) to the eraser mode (6) may be similar to those of the first embodiment.

In the voice recognition mode, the language selection mode, and the industry selection mode, the gesture operation of pointing the index finger, the gesture operation of stretching the thumb, the gesture operation of closing the thumb, the gesture operation of swinging four fingers to the left, and the gesture operation of swinging four fingers to the right are available.

If the apparatus 2 recognizes a gesture operation of drawing a circle with the palm of a hand (an example of the first gesture operation), for example, in the gesture recognition mode, the apparatus 2 transitions to the voice recognition mode ((7) of FIG. 39). The voice recognition mode is a mode for recognizing and converting the voice of the user into text data. If the apparatus 2 recognizes the gesture operation of swinging two fingers horizontally, for example, in the voice recognition mode, the apparatus 2 transitions to the language selection mode. If the apparatus 2 recognizes the gesture operation of swinging three fingers horizontally, for example, in the voice recognition mode, the apparatus 2 transitions to the industry selection mode.

The language selection mode ((8) of FIG. 39) is a mode for receiving the selection of a language for voice recognition in the voice recognition mode. When the apparatus 2 transitions to the language selection mode, the apparatus 2 displays a list of languages. If the user moves the pointer to a particular language in the list with the forefinger and stretches the thumb, the apparatus 2 receives the selection of the particular language located at the position of the pointer.

The industry selection mode ((9) of FIG. 39) is a mode for receiving the selection of a voice recognition dictionary for a particular industry to be used in the voice recognition. The dictionary used in voice recognition varies depending on the industry. In the medical or architectural industry, it is desirable to use a voice recognition dictionary dedicated to the industry. When the apparatus 2 transitions to the industry selection mode, the apparatus 2 displays a list of industries. If the user moves the pointer to a particular industry in the list with the forefinger and stretches the thumb, the apparatus 2 receives the selection of the particular industry located at the position of the pointer.

As described above, the apparatus 2 of the second embodiment has a plurality of modes in each of the layers lower than the first layer. When the apparatus 2 transitions from a certain layer to a lower layer, the lower layer includes a plurality of modes. Therefore, a gesture operation learned by the user for a layer or mode is also applicable to a different layer or mode. Consequently, more operations are performed with less gesture operations.

Functions of the apparatus 2 of the second embodiment will be described.

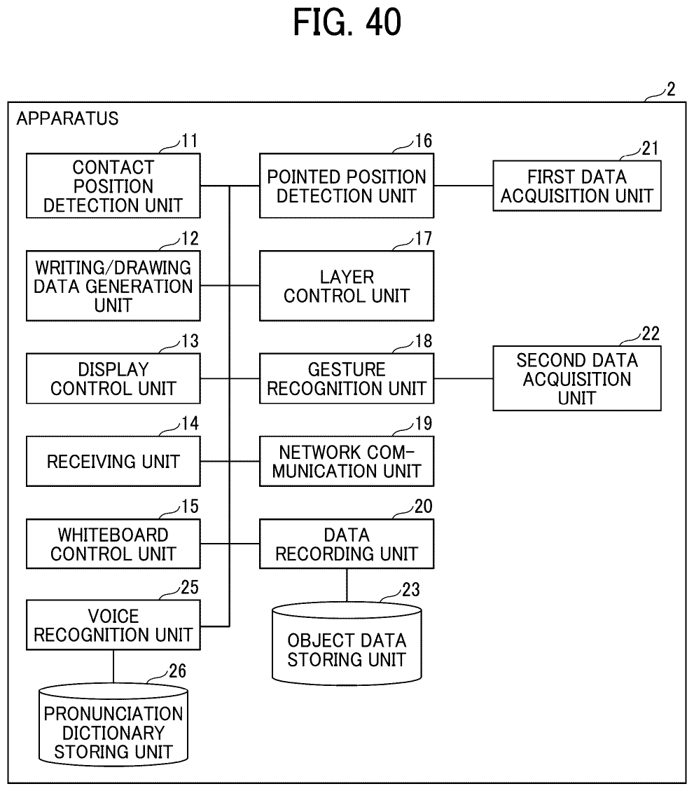

FIG. 40 is a functional block diagram illustrating functional blocks of the apparatus 2 of the second embodiment. The following description of FIG. 40 will focus on differences from FIG. 6. The apparatus 2 of the second embodiment additionally includes a voice recognition unit 25 and a pronunciation dictionary storing unit 26.

The voice recognition unit 25 extracts feature values of the voice from audio data input from the microphone 440 and encoded into pulse-code modulation (PCM) format (i.e., performs acoustic analysis), extracts phonemes, identifies words with a pronunciation dictionary, converts the words into text, and outputs text data. As a language model for converting words into text, deep neural network-hidden markov mode (DNN-HMM) by recurrent neural network (RNN) may be used.

The pronunciation dictionary storing unit 26 stores, in addition to general-purpose pronunciation dictionary data, pronunciation dictionaries dedicated to particular industries such as the medical, architectural, and chemical industries. The pronunciation dictionary storing unit 26 is formed in the SSD 404, for example. Alternatively, the pronunciation dictionary storing unit 26 may reside on a network. From the pronunciation dictionary storing unit 26, the voice recognition unit 25 reads and uses pronunciation dictionary data selected by the user.

A process flow from the start to the end of the voice recognition mode will be described.

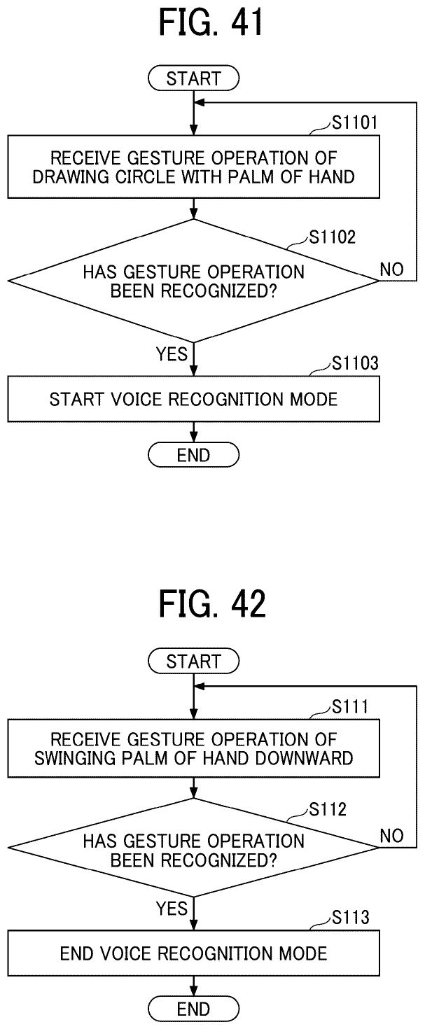

FIG. 41 is a flowchart illustrating a process in which the user causes the apparatus 2 to transition to the voice recognition mode with a gesture operation. At the beginning of the process in FIG. 41, the apparatus 2 is in the gesture recognition mode, having recognized the palm of a hand.

At step S1101, the apparatus 2 receives from the user the gesture operation of drawing a circle with the palm of a hand. At step S1102, the gesture recognition unit 18 analyzes the range image data from the range image sensor 460, and determines whether the gesture operation of drawing a circle with the palm of a hand has been recognized. If the gesture recognition unit 18 recognizes this gesture operation (YES at step S1102), the layer control unit 17 causes transition to the voice recognition mode at step S1103.

In FIG. 41, drawing a circle with the palm of a hand is the gesture operation for starting the voice recognition mode. The gesture operation for starting the voice recognition mode, however, may be any gesture operation readily performed by the user with a hand. For example, the gesture operation may be swinging the palm of a hand downward, opening or closing five fingers, or turning the palm of a hand.

FIG. 42 is a flowchart illustrating a process in which the user ends the voice recognition mode with a gesture operation. Herein, the apparatus 2 is in the voice recognition mode.

At step S111, the apparatus 2 in the voice recognition mode receives from the user the gesture operation of swinging the palm of a hand downward. At step S112, the gesture recognition unit 18 analyzes the range image data from the range image sensor 460, and determines whether the gesture operation of swinging the palm of a hand downward has been recognized.

If the gesture recognition unit 18 recognizes this gesture operation (YES at step S112), the layer control unit 17 ends the voice recognition mode at step S113. If the gesture recognition unit 18 recognizes, in the second layer (e.g., the voice recognition mode), the gesture operation for ending the recognition of a gesture operation classified in the second layer, the gesture recognition unit 18 becomes ready to recognize a gesture operation classified in the top layer (e.g., the gesture recognition mode).

In FIG. 42, swinging the palm of a hand downward is the gesture operation for ending the voice recognition mode. The gesture operation for ending the voice recognition mode, however, may be any gesture operation readily performed by the user with a hand. For example, the gesture operation may be closing the forefinger, stretching the forefinger and the little finger, or stretching the little finger.

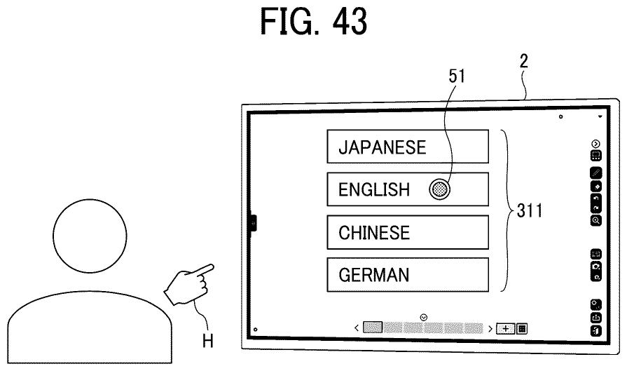

Gesture operations performed from the start to the end of the language selection mode will be described with reference to FIG. 43 and other drawings.

FIG. 43 illustrates a gesture operation for the apparatus 2 to display the pointer 51 in the language selection mode. When the apparatus 2 transitions to the language selection mode, the display control unit 13 displays a language list 311. If the user then points the forefinger at the apparatus 2, the range image sensor 460 captures still or video images of this gesture operation. The gesture recognition unit 18 analyzes the range image data and detects that the forefinger has been pointed at the display 3.

In response to detection that the forefinger has been pointed at the display 3 in the language selection mode, the pointed position detection unit 16 calculates the pointed coordinates with the image data input from the right finger image capturing camera 471 and the left finger image capturing camera 472. The display control unit 13 displays the pointer 51 at the calculated coordinates. If the user moves the forefinger in this state, the display control unit 13 moves the pointer 51 to follow the pointed coordinates. If the user then stretches the thumb at the position of a particular language in the language list 311, the apparatus 2 receives the selection of the language.

A process flow from the start to the end of the language selection mode will be described.

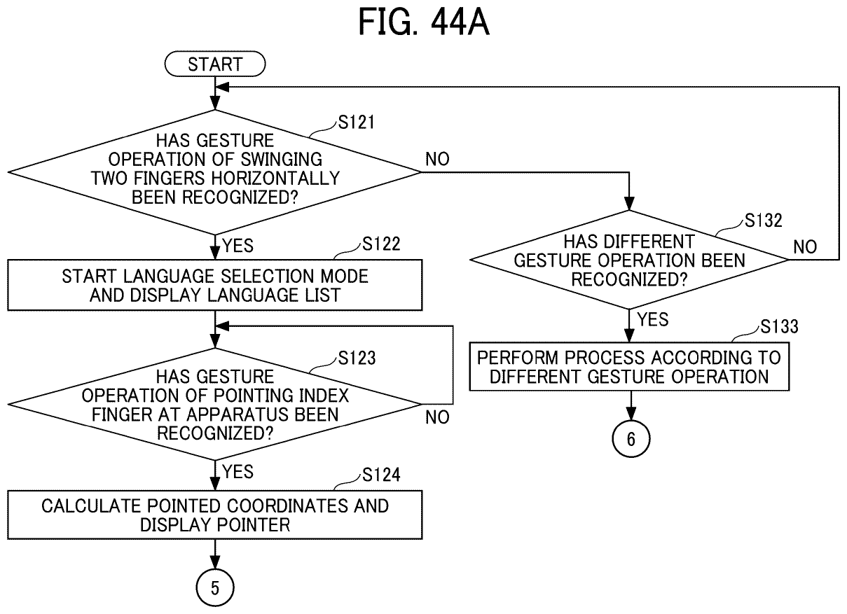

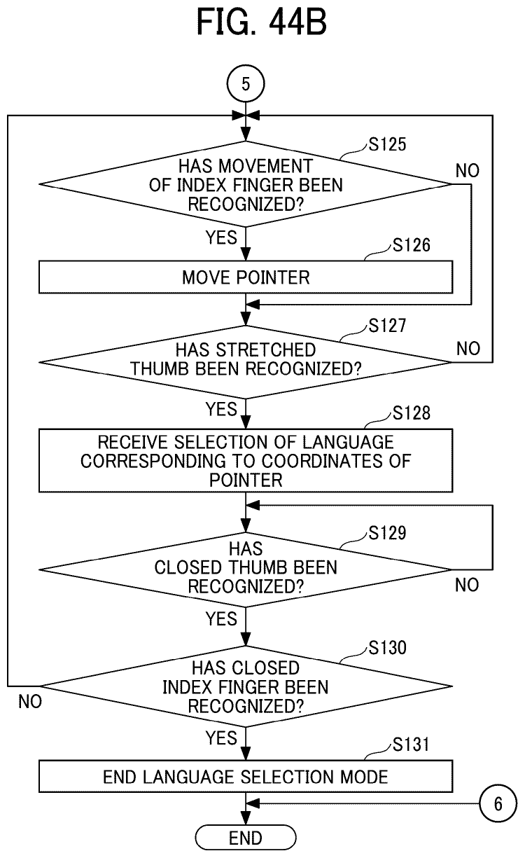

FIGS. 44A and 44B (FIG. 44) are a flowchart illustrating a process in which the user causes the apparatus 2 to transition to the language selection mode and end the language selection mode with gesture operations. At the beginning of the process in FIGS. 44A and 44B, the apparatus 2 is in the voice recognition mode, having recognized the gesture operation of drawing a circle with the palm of a hand.

At step S121, the gesture recognition unit 18 analyzes the range image data from the range image sensor 460, and determines whether the gesture operation of swinging two fingers horizontally has been recognized. If YES at step S121, the process proceeds to step S122. If NO at step S121, the process proceeds to step S132.

At step S122, the layer control unit 17 causes transition to the language selection mode, and the display control unit 13 displays the language list 311 on the display 3.

At step S123, the gesture recognition unit 18 analyzes the range image data from the range image sensor 460, and determines whether the gesture operation of pointing the forefinger at the display 3 of the apparatus 2 has been recognized. If YES at step S123, the process proceeds to step S124. If NO at step S123, the process repeats step S123.

At step S124, the pointed position detection unit 16 calculates the coordinates pointed by the forefinger, and the display control unit 13 displays the pointer 51 at the calculated coordinates.

At step S125, the pointed position detection unit 16 determines whether movement of the forefinger has been detected based on the coordinates pointed by the forefinger. If YES at step S125, the process proceeds to step S126. If NO at step S125, the process proceeds to step S127.

At step S126, the display control unit 13 moves the pointer 51 to the coordinates pointed by the forefinger and calculated by the pointed position detection unit 16.

At step S127, the gesture recognition unit 18 analyzes the range image data from the range image sensor 460, and determines whether the gesture operation of stretching the thumb with the forefinger pointing at the display 3 has been recognized. If YES at step S127, the process proceeds to step S128. If NO at step S127, the process returns to step S125.

At step S128, the receiving unit 14 receives the selection of a language displayed at the coordinates pointed by the forefinger and detected by the pointed position detection unit 16.

At step S129, the gesture recognition unit 18 analyzes the range image data from the range image sensor 460, and determines whether the gesture operation of closing the thumb has been recognized. If YES at step S129, the process proceeds to step S130. If NO at step S129, the process repeats step S129.

At step S130, the gesture recognition unit 18 analyzes the range image data from the range image sensor 460, and determines whether the gesture operation of closing the forefinger has been recognized. If YES at step S130, the process proceeds to step S131. If NO at step S130, the process returns to step S125.

At step S131, with the gesture operation of closing the forefinger having been recognized, the layer control unit 17 ends the language selection mode. The language selection mode transitions to the voice recognition mode. If the gesture recognition unit 18 recognizes, in the third layer (e.g., the language selection mode), the gesture operation for ending the recognition of a gesture operation classified in the third layer, the gesture recognition unit 18 becomes ready to recognize a gesture operation classified in the second layer (e.g., the voice recognition mode). The gesture operation for ending the language selection mode is the same as the gesture operation for ending the industry selection mode. Thereby, the number of gesture operations to be memorized by the user is reduced.

At step S132, the gesture recognition unit 18 analyzes the range image data from the range image sensor 460, and determines whether a different gesture operation has been recognized. Herein, the different gesture operation is the gesture operation of swinging three fingers horizontally, swinging three fingers vertically, swinging four fingers to the left, or swinging four fingers to the right, for example. If YES at step S132, the process proceeds to step S133. If NO at step S132, the process returns to step S121.

At step S133, the gesture recognition unit 18 performs a process according to the different gesture operation.

In FIGS. 44A and 44B, swinging two fingers horizontally is the gesture operation for starting the language selection mode. The gesture operation for starting the language selection mode, however, may be any gesture operation readily performed by the user with a hand. For example, the gesture operation may be swinging two fingers vertically, swinging three fingers horizontally, or swinging three fingers vertically.

In FIGS. 44A and 44B, closing the forefinger is the gesture operation for ending the language selection mode. The gesture operation for ending the language selection mode, however, may be any gesture operation readily performed by the user with a hand. For example, the gesture operation may be stretching the forefinger and the little finger or stretching the little finger.

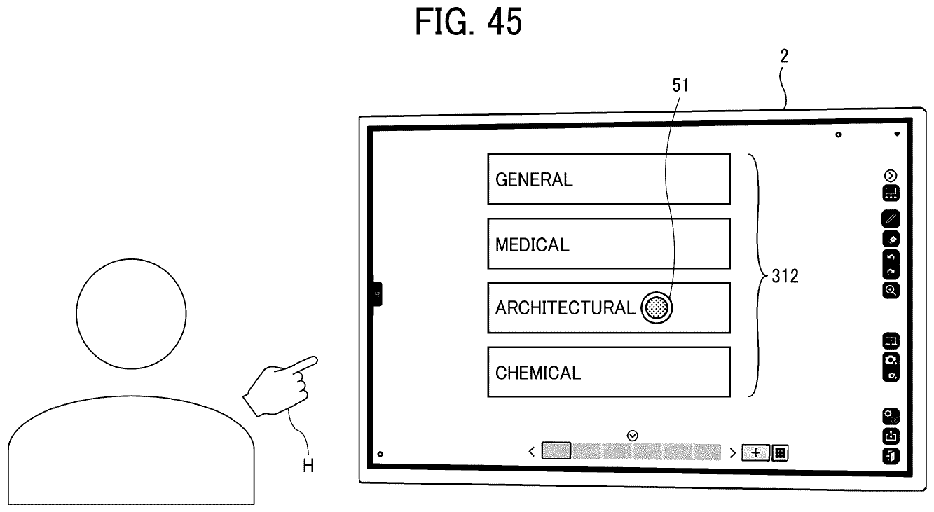

Gesture operations performed from the start to the end of the industry selection mode will be described with reference to FIG. 45.

FIG. 45 illustrates a gesture operation for the apparatus 2 to display the pointer 51 in the industry selection mode. When the apparatus 2 transitions to the industry selection mode, the display control unit 13 displays an industry list 312. If the user points the forefinger at the apparatus 2, the range image sensor 460 captures still or video images of this gesture operation. The gesture recognition unit 18 analyzes the range image data and detects that the forefinger has been pointed at the display 3.

In response to detection that the forefinger has been pointed at the display 3 in the industry selection mode, the pointed position detection unit 16 calculates the pointed coordinates with the image data input from the right finger image capturing camera 471 and the left finger image capturing camera 472. The display control unit 13 displays the pointer 51 at the calculated coordinates. If the user moves the forefinger in this state, the display control unit 13 moves the pointer 51 to follow the pointed coordinates. If the user then stretches the thumb at the position of a particular industry in the industry list 312, the apparatus 2 receives the selection of the industry.

A process flow from the start to the end of the industry selection mode will be described.

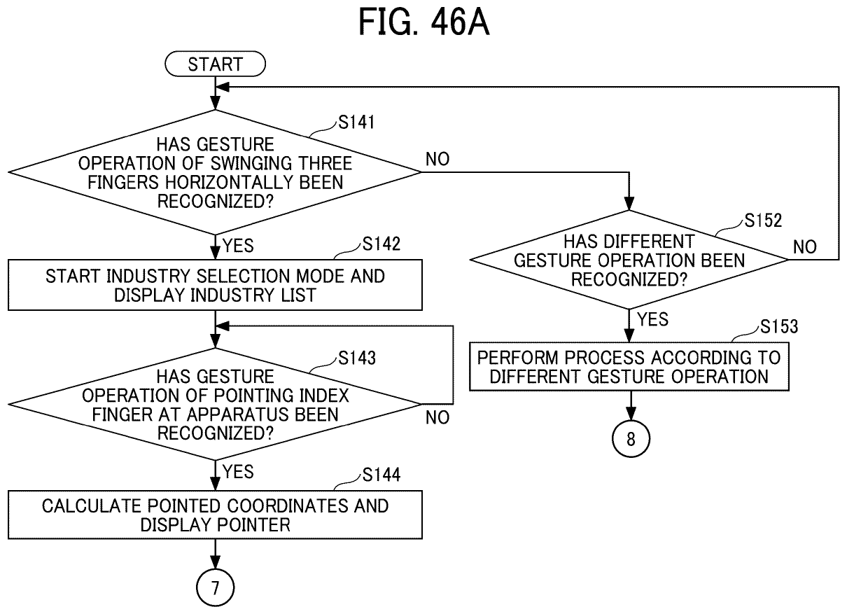

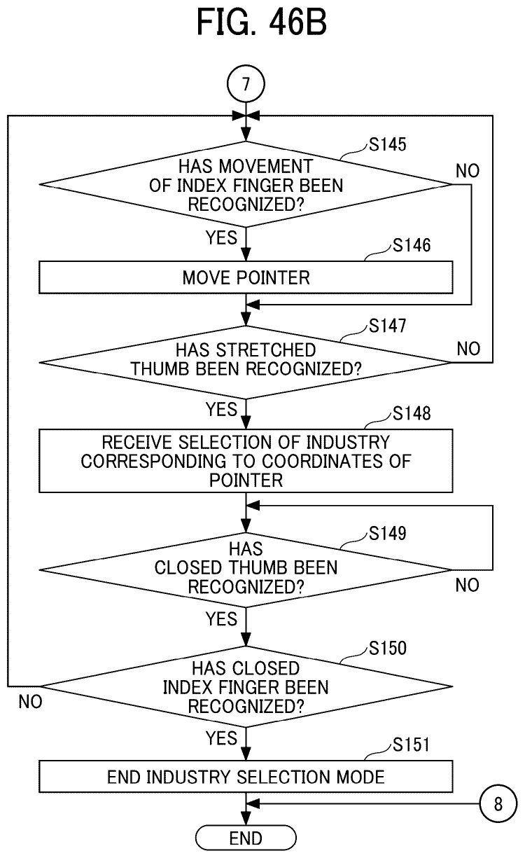

FIGS. 46A and 46B (FIG. 46) are a flowchart illustrating a process in which the user causes the apparatus 2 to transition to the industry selection mode and end the industry selection mode with gesture operations. At the beginning of the process in FIGS. 46A and 46B, the apparatus 2 is in the voice recognition mode, having recognized the gesture operation of drawing a circle with the palm of a hand.

The following description of FIGS. 46A and 46B will focus on differences from FIGS. 44A and 44B.

At step S141, the gesture recognition unit 18 analyzes the range image data from the range image sensor 460, and determines whether the gesture operation of swinging three fingers horizontally has been recognized. If YES at step S141, the process proceeds to step S142. If NO at step S141, the process proceeds to step S152.

At step S142, the layer control unit 17 causes transition to the industry selection mode, and the display control unit 13 displays the industry list 312 on the display 3. The processes of steps S143 to S147 may be similar to the processes of steps S123 to S127 in FIGS. 44A and 44B.

At step S148, the receiving unit 14 receives the selection of an industry displayed at the coordinates pointed by the forefinger and detected by the pointed position detection unit 16. The subsequent processes may be similar to the corresponding processes in FIG. 44B.

In addition to the features of the apparatus 2 of the first embodiment, the apparatus 2 of the second embodiment has a plurality modes in each of the layers lower than the first layer. When the apparatus 2 transitions from a certain layer to a lower layer, the lower layer includes a plurality of modes. Therefore, a gesture operation learned by the user for a layer or mode is also applicable to a different layer or mode. Consequently, more operations are performed with less gesture operations.

A third embodiment of the present disclosure will be described.

In the third embodiment, a display system will be described in which an information processing system residing on a network performs gesture recognition and transmits to the apparatus 2 a recognized gesture operation and the coordinates pointed by the forefinger.

In the following description of the third embodiment, reference numerals identical or similar to those in the first or second embodiment designate identical or similar components or functions depending on the drawing. Therefore, the following description may not include the already described components or may focus on differences from the first or second embodiment.

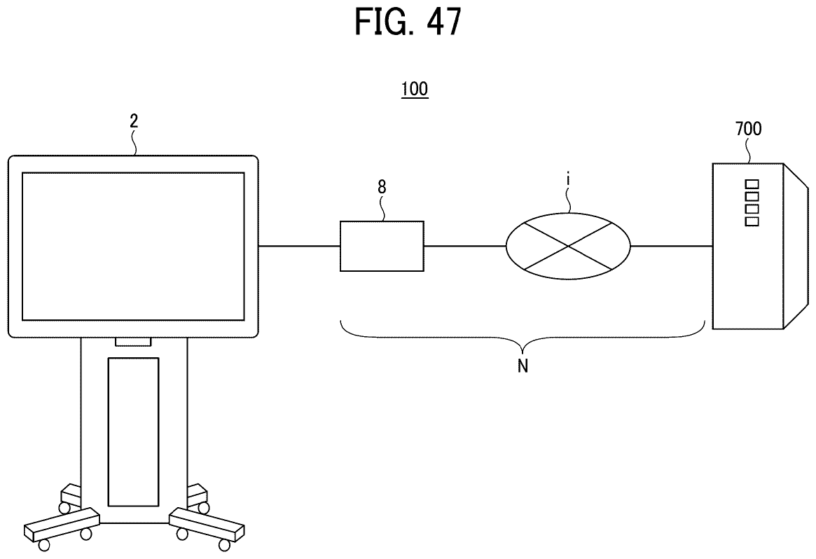

FIG. 47 illustrates an exemplary system configuration of a display system 100 of the third embodiment. The display system 100 includes the apparatus 2 and an information processing system 700, which are communicable with each other via a network N.

The apparatus 2 is installed in a facility such as a company office, and is connected to a wireless fidelity (Wi-Fi®) network or a LAN established in the facility. The information processing system 700 is installed in a data center, for example. The apparatus 2 is connected to the Internet i via a firewall (FW) 8. The information processing system 700 is also connected to the Internet i via, for example, a high-speed LAN established in the data center.

The apparatus 2 may be connected to the Internet i via wireless communication using a mobile phone network, for example. In this case, wireless communication conforms to a communication standard such as third generation (3G), fourth generation (4G), fifth generation (5G), long term evolution (LTE), or worldwide interoperability for microwave access (WiMAX).

The information processing system 700 includes one or more information processing apparatuses that function as a server to provide a service to the apparatus 2. A server is a computer or software that functions to provide information or a processing result to a client in response to a request from the client. The information processing system 700 receives from the apparatus 2 the image data of the images captured by the right finger image capturing camera 471 and the left finger image capturing camera 472 and the range image data of the images captured by the range image sensor 460, as described later. The information processing system 700 transmits to the apparatus 2 a recognized gesture operation and calculated coordinates pointed by the forefinger. Thereby, a processing load on the apparatus 2 is reduced.

The configuration of the apparatus 2 of the third embodiment may be similar to that of the first embodiment. It suffices if the apparatus 2 of the third embodiment includes a touch panel, a display, cameras (e.g., a range image sensor and finger image capturing cameras), and a communication function. The apparatus 2 of the third embodiment may include a plurality of computing devices configured to communicate with each other.

In the third embodiment, a commonly used information processing apparatus such as a PC or a tablet terminal operates as the apparatus 2 with a web browser or a dedicated application. The web browser or the dedicated application communicates with the information processing system 700. If the web browser is running, the user inputs or selects a uniform resource locator (URL) of the information processing system 700 to connect a display device to the information processing system 700. On the web browser, the apparatus 2 runs a web application provided by the information processing system 700. A web application refers to software executed on a web browser and run by the cooperation between a program running on the web browser in a programming language (e.g., JavaScript®) and a program running on a web server or to a mechanism thereof.

If the dedicated application is running, the apparatus 2 connects to a previously registered URL of the information processing system 700. The dedicated application, which includes a program and a user interface, transmits and receives information for the program to and from the information processing system 700 and displays the information on the user interface.

A communication method employed here may use a general-purpose communication protocol such as hypertext transfer protocol (HTTP), hypertext transfer protocol secure (HTTPS), or WebSocket or a dedicated communication protocol.

An exemplary hardware configuration of the display system 100 will be described.

The apparatus 2 of the third embodiment may have a similar hardware configuration to that illustrated in FIG. 5. In the third embodiment, an exemplary hardware configuration of the information processing system 700 will be described.

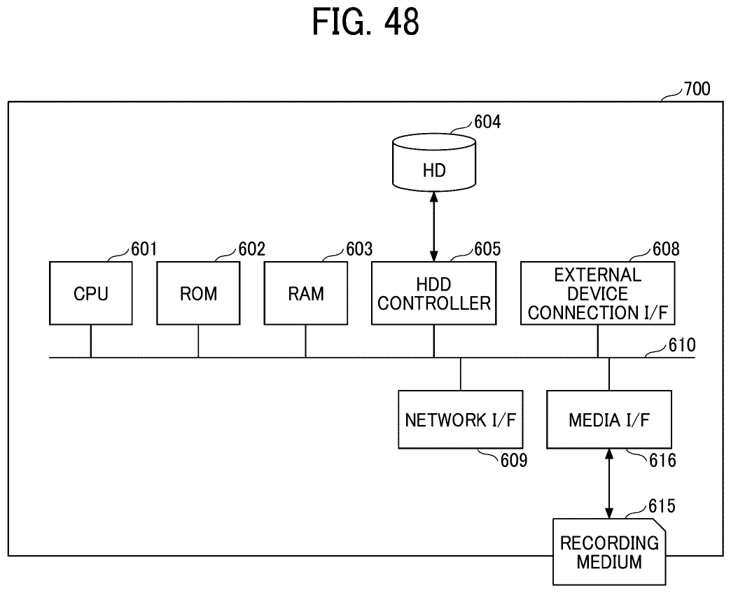

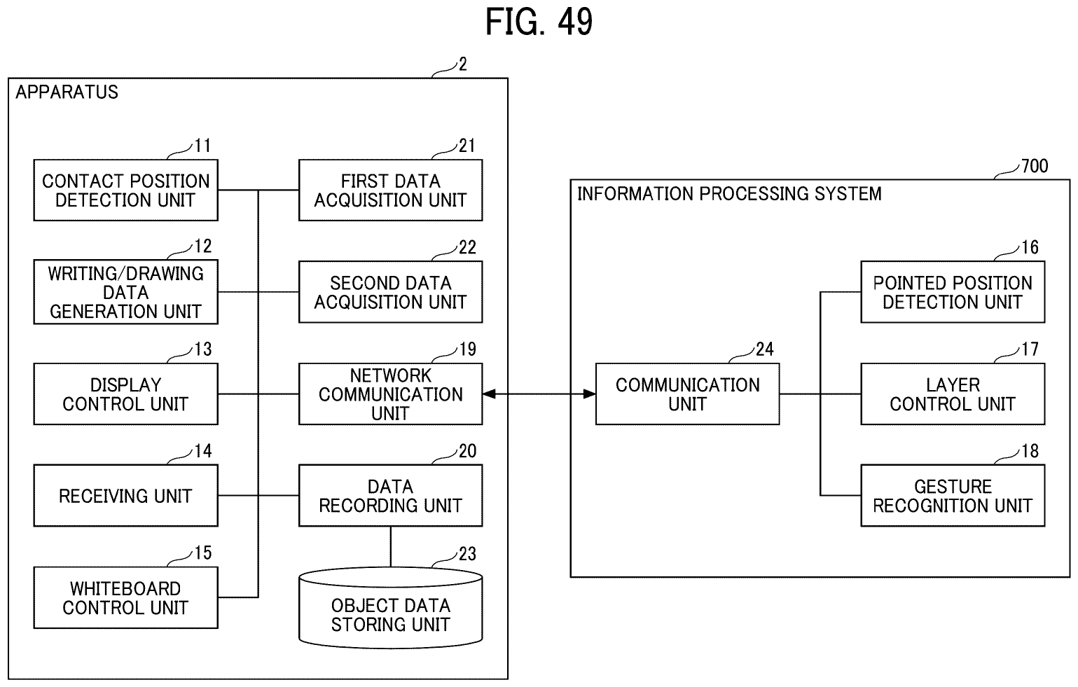

FIG. 48 is a diagram illustrating a hardware configuration of the information processing system 700. As illustrated in FIG. 48, the information processing system 700, which is implemented by a computer, includes a CPU 601, a ROM 602, a RAM 603, a hard disk (HD) 604, a hard disk drive (HDD) controller 605, an external device connection I/F 608, a network I/F 609, a bus line 610, and a media I/F 616.

The CPU 601 controls overall operation of the information processing system 700. The ROM 602 stores programs used to drive the CPU 601 such as an IPL. The RAM 603 is used as a work area of the CPU 601. The HD 604 stores various data such as programs. The HDD controller 605 controls the writing and reading of various data to and from the HD 604 under the control of the CPU 601. The external device connection I/F 608 is an interface for connecting various external devices to the information processing system 700. The external devices in this case include a USB memory and a printer, for example. The network I/F 609 is an interface for performing data communication via a communication network. The bus line 610 includes address buses and data buses for electrically connecting the CPU 601 and the other components in FIG. 48 to each other. The media I/F 616 controls the writing (i.e., storage) and reading of data to and from a recording medium 615 such as a flash memory.

Functions of the display system 100 will be described with FIG. 49.

FIG. 49 is a functional block diagram illustrating an example of functional blocks of the display system 100. The following description of FIG. 49 will focus on differences from FIG. 6.

In the third embodiment, the apparatus 2 includes the contact position detection unit 11, the writing/drawing data generation unit 12, the display control unit 13, the receiving unit 14, the whiteboard control unit 15, the network communication unit 19, the data recording unit 20, the first data acquisition unit 21, the second data acquisition unit 22, and the object data storing unit 23. These functions may be similar to those of the first or second embodiment or may be different therefrom, but any difference is insignificant in the following description of the third embodiment.

The information processing system 700 includes functions such as the pointed position detection unit 16, the layer control unit 17, the gesture recognition unit 18, and a communication unit 24. Each of the functions of the information processing system 700 is a function or means implemented when at least one of the components illustrated in FIG. 48 operates based on a command from the CPU 601 in accordance with a program deployed in the RAM 603 from the HD 604.

The communication unit 24 receives, from the apparatus 2, data such as the range image data and the image data obtained by the right finger image capturing camera 471 and the left finger image capturing camera 472. The communication unit 24 further transmits, to the apparatus 2, data such as the recognized gesture operation and the coordinates pointed by the forefinger. The other functions of the information processing system 700 may be similar to those of the first or second embodiment or may be different therefrom, but any difference is insignificant in the following description of the third embodiment.

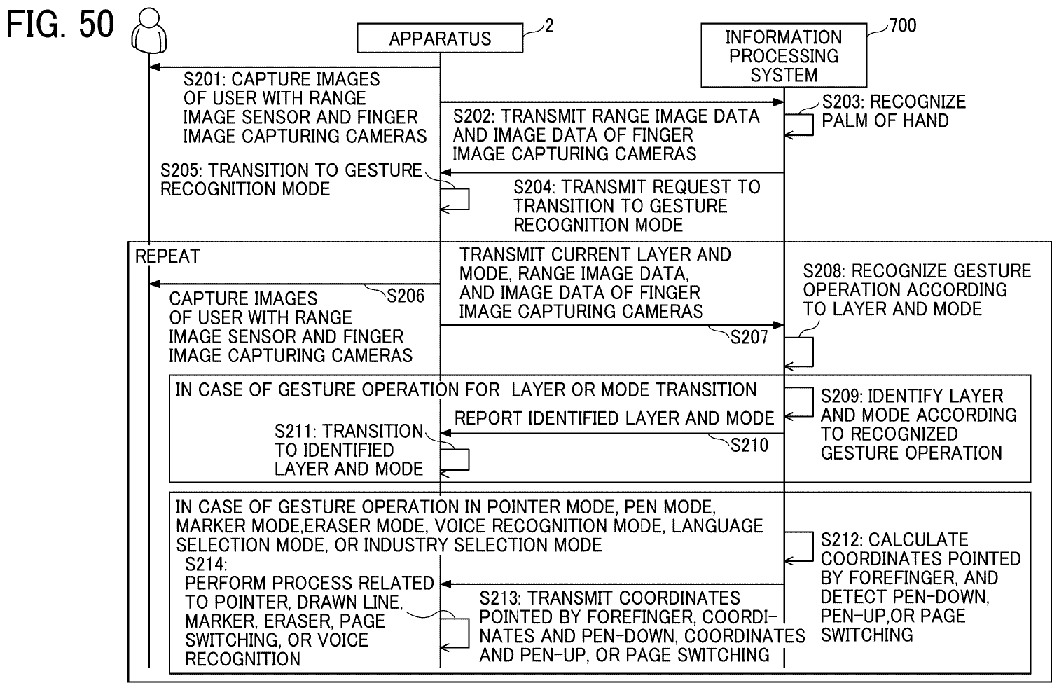

FIG. 50 is a sequence diagram illustrating a process in which the apparatus 2 and the information processing system 700 communicate with each other to perform gesture recognition and display the coordinates pointed by the forefinger.

Herein, the apparatus 2 is in the initial state. At step S201, the range image sensor 460, the right finger image capturing camera 471, and the left finger image capturing camera 472 capture images of the user.

At step S202, the first data acquisition unit 21 acquires the image data from the right finger image capturing camera 471 and the left finger image capturing camera 472. The second data acquisition unit 22 acquires the range image data from the range image sensor 460. The network communication unit 19 transmits the range image data and the image data of the images captured by the right finger image capturing camera 471 and the left finger image capturing camera 472 to the information processing system 700. The network communication unit 19 may report to the information processing system 700 that the apparatus 2 is in the initial state.

At step S203, the communication unit 24 of the information processing system 700 receives the range image data and the image data. The gesture recognition unit 18 analyzes the range image data and determines whether the palm of a hand has been recognized in the initial state. If the gesture recognition unit 18 recognizes the palm of a hand, the layer control unit 17 determines the transition to the gesture recognition mode based on the recognition of the palm of a hand in the initial state.

At step S204, the communication unit 24 transmits to the apparatus 2 a request to transition to the gesture recognition mode.

At step S205, the network communication unit 19 receives the request, and the apparatus 2 transitions to the gesture recognition mode.

The following processes of steps S206 to S214 are repeated until the apparatus 2 returns to the initial state.

At step S206, the range image sensor 460, the right finger image capturing camera 471, and the left finger image capturing camera 472 capture images of the user.

At step S207, the network communication unit 19 transmits the current layer and mode, the range image data, and the image data of the images captured by the right finger image capturing camera 471 and the left finger image capturing camera 472 to the information processing system 700.

At step S208, the communication unit 24 of the information processing system 700 receives the current layer and mode, the range image data, and the image data. The gesture recognition unit 18 analyzes the range image data and recognizes the gesture operation according to the current layer and mode.

At step S209, if the recognized gesture operation is a gesture operation for layer or mode transition, the layer control unit 17 identifies the layer and mode according to the recognized gesture operation.

At step S210, the communication unit 24 of the information processing system 700 reports the identified layer and mode to the apparatus 2.

At step S211, the network communication unit 19 of the apparatus 2 receives the layer and mode, and the apparatus 2 transitions to the layer and mode. For example, the display control unit 13 displays a menu according to the pointer mode, the pen mode, the marker mode, the eraser mode, the voice recognition mode, the language selection mode, or the industry selection mode.

At step S212, if the recognized gesture operation is not a gesture operation for layer or mode transition but a gesture operation available in the current mode, and if the gesture recognition unit 18 recognizes the forefinger, the pointed position detection unit 16 calculates the coordinates pointed by the forefinger. If the gesture recognition unit 18 further recognizes the gesture operation of stretching or closing the thumb, the gesture recognition unit 18 identifies the pend-down mode or the pen-up mode. In the eraser mode, pen-down means the transition to the mode in which the virtual eraser is in contact with the display, and pen-up means the transition to the mode in which the virtual eraser is in separate from the display. If the gesture recognition unit 18 recognizes the gesture operation of swinging four fingers to the left or right, the gesture recognition unit 18 detects page switching.

At step S213, the communication unit 24 of the information processing system 700 reports to the apparatus 2 the coordinates pointed by the forefinger, the coordinates pointed by the forefinger and the pen-down mode, the coordinates pointed by the forefinger and the pen-up mode, or page switching.

At step S214, the network communication unit 19 of the apparatus 2 receives the coordinates pointed by the forefinger, the coordinates pointed by the forefinger and the pen-down mode, the coordinates pointed by the forefinger and the pen-up mode, or page switching. The apparatus 2 then performs a process related to the pointer, the drawn line, the marker, the eraser, page switching, or voice recognition.

In addition to the features of the first or second embodiment, the third embodiment enables controlling the apparatus 2 with a gesture operation when the apparatus 2 is connected to a network.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the foregoing embodiments, the transition to the gesture recognition mode takes place when the apparatus 2 recognizes the palm of a hand in the initial state. The method of transitioning to the gesture recognition mode, however, is not limited thereto. For example, the transition to the gesture recognition mode may take place when the apparatus 2 recognizes a particular shape or motion of an object. Further, different gestures from the above-described gestures may be used as the gesture operation for transitioning to the pointer mode, the pen mode, the marker mode, or the eraser mode and the gesture operation for switching the page.

The apparatus 2 may be called an electronic whiteboard or an electronic information board, for example, as well as an interactive whiteboard. Further, the present embodiments are not limited to the interactive whiteboard, and are preferably applicable to any information processing apparatus equipped with a touch panel. The information processing apparatus equipped with a touch panel may be a PC, tablet terminal, or smartphone equipped with a touch panel, for example. Such an information processing apparatus is normally used as a general-purpose information processing apparatus, and is operable as the apparatus 2 by the user executing an application for causing the information processing apparatus to function as an apparatus.

The apparatus 2 may project an image with a projector. In this case, the apparatus 2 detects the pointed coordinates with the method described above in the embodiments, and the projector projects the image of a drawn line, for example, based on the trajectory of the coordinates.

In the embodiments, the apparatus 2 recognizes the gesture operation and calculates the coordinates pointed by the user with the forefinger. Alternatively, a server apparatus connected to the apparatus 2 via a network may perform at least one of the recognition of the gesture operation or the calculation of the coordinates. In this case, the apparatus 2 transmits in real time the image data of the images captured by the right finger image capturing camera 471 and the left finger image capturing camera 472 and the range image data of the images captured by from the range image sensor 460 to the server apparatus. The server apparatus transmits the recognized gesture operation and the calculated coordinates to the apparatus 2. Thereby, the processing load on the apparatus 2 is reduced.

In the embodiments, the apparatus 2 calculates the coordinates pointed by the index finger. Alternatively, the coordinate on the display 3 may be pointed by a different finger. Further, in the embodiments, stretching the thumb is the gesture operation for pen-down, and closing the thumb is the gesture operation for pen-up. Alternatively, different gesture operations may be used as the gesture operation for pen-down and the gesture operation for pen-up.

The apparatus 2 may display the current mode or status on the display 3. The apparatus 2 may display text or an icon indicating the current mode or status such as the initial state, the gesture recognition mode, the pen mode, the marker mode, or the eraser mode at the upper-right corner of the display 3, for example. In this case, the apparatus 2 may preferably display, for example, animations indicating gesture operations available in the current mode or status. Alternatively, when the user presses the icon, the apparatus 2 may play an animation or video for guiding the user through the gesture operations.

In the configuration examples illustrated in FIG. 6 and other drawings, the processing units of the apparatus 2 are divided in accordance with major functions of the apparatus 2 to facilitate the understanding of the processing of the apparatus 2. It should be noted that the present disclosure is not limited by how the processing units are divided or the names thereof. The processing of the apparatus 2 may be divided into more processing units in accordance with the processing. Further, any of the above-described processing units may be subdivided to include more processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

The present disclosure relates to the following aspects.

According to a first aspect, an apparatus recognizes a gesture operation corresponding to a motion of a pointing object, and receives an operation according to the gesture operation. The apparatus includes a data acquisition unit and a gesture recognition unit. The data acquisition unit acquires information related to a shape of the pointing object from a sensor that acquires the information. Based on the information acquired by the data acquisition unit, the gesture recognition unit recognizes the gesture operation. The gesture operation is recognizable in one of at least three layers in which a plurality of gesture operations are classified. When the gesture recognition unit recognizes a first gesture operation in a top layer of the at least three layers, the gesture recognition unit becomes ready to recognize a gesture operation classified in a second layer of the at least three layers. When the gesture recognition unit recognizes a second gesture operation in the second layer, the gesture recognition unit becomes ready to recognize a gesture operation classified in a third layer of the at least three layers.

According to a second aspect, in the apparatus of the first aspect, when the gesture recognition unit recognizes, in the second layer, a gesture operation for ending the recognition of the gesture operation classified in the second layer, the gesture recognition unit becomes ready to recognize a gesture operation classified in the top layer. When the gesture recognition unit recognizes, in the third layer, a gesture operation for ending the recognition of the gesture operation classified in the third layer, the gesture recognition unit becomes ready to recognize the gesture operation classified in the second layer.

According to a third aspect, the apparatus of the first or second aspect includes a layer control unit that causes transition from a current layer to an upper layer or a lower layer in the at least three layers.

According to a fourth aspect, the apparatus of the first or second aspect includes a layer control unit that identifies the top layer in response to recognition of the pointing object in an initial state. In response to recognition of the pointing object in the initial state, the gesture recognition unit becomes ready to recognize a gesture operation classified in the top layer.

According to a fifth aspect, in the apparatus of the fourth aspect, the second layer includes a plurality of modes for using a plurality of particular features of the apparatus. When the gesture recognition unit recognizes the first gesture operation in the top layer, the layer control unit causes transition to the second layer and to a mode of the plurality of modes in the second layer. The mode in the second layer is associated with the recognized first gesture operation.

According to a sixth aspect, the apparatus of the fifth aspect includes a plurality of image capturing devices, a display, a pointed position detection unit, and a display control unit. The plurality of image capturing devices capture a plurality of images of the display of the apparatus and a hand of a user. The hand of the user is the pointing object. The display displays a drawn line input in handwriting on a touch panel with a pen or finger. The pointed position detection unit analyzes image data of the plurality of images captured by the plurality of image capturing devices, and detects a plurality of coordinates on the display pointed by a forefinger of the user. When the gesture recognition unit recognizes, in the top layer, the first gesture operation to transition to a pointer mode included in the plurality of modes in the second layer, the layer control unit causes transition from the top layer to the pointer mode in the second layer. The display control unit displays a pointer at the plurality of coordinates on the display detected by the pointed position detection unit.

According to a seventh aspect, in the apparatus of the fourth aspect, the third layer includes a plurality of modes for using a plurality of particular features of the apparatus. When the gesture recognition unit recognizes the second gesture operation in the second layer, the layer control unit causes transition to the third layer and to a mode included in the plurality of modes in the third layer. The mode in the third layer is associated with the recognized second gesture operation.

According to an eighth aspect, in the apparatus of the seventh aspect, the second layer includes a plurality of modes for using a plurality of particular features of the apparatus. Each mode of the plurality of modes in the second layer is associated with one or more second gesture operations recognizable by the gesture recognition unit. When the gesture recognition unit recognizes, in a mode of the plurality of modes in the second layer, a second gesture operation associated with the mode, the layer control unit causes transition to the third layer and to the mode of the plurality of modes in the third layer. The mode in the third layer is associated with the recognized second gesture operation.

According to a ninth aspect, in the apparatus of the seventh or eighth aspect, when the layer control unit causes transition to a pen mode included in the plurality of modes in the third layer, the gesture recognition unit recognizes a gesture operation for displaying a drawn line on a display.

According to a tenth aspect, the apparatus of the ninth aspect includes a plurality of image capturing devices, a pointed position detection unit, and a display control unit. The plurality of image capturing devices capture a plurality of images of a display of the apparatus and a hand of a user. The hand of the user is the pointing object. The pointed position detection unit analyzes image data of the plurality of images captured by the plurality of image capturing devices, and detects a plurality of coordinates on the display pointed by a forefinger of the user. The display control unit displays the drawn line as a trajectory of the plurality of coordinates detected by the pointed position detection unit. When the gesture recognition unit recognizes a gesture operation of pointing the forefinger at the display and moving a pen down in the pen mode, the gesture recognition unit identifies a pen-down mode. When the gesture recognition unit recognizes a gesture operation of moving the pen up in the pen mode, the gesture recognition unit identifies a pen-up mode, and the display control unit stops drawing the drawn line.

According to an eleventh aspect, in the apparatus of the tenth aspect, the display control unit displays a pen icon at the plurality of coordinates detected by the pointed position detection unit in the pen mode.

According to a twelfth aspect, in the apparatus of the eleventh aspect, when the gesture recognition unit recognizes the gesture operation of pointing the forefinger at the display and moving the pen down in the pen mode, the gesture recognition unit identifies the pen-down mode, and the display control unit displays the pen icon in a style different from a style used in a mode previous to the pen-down mode.

According to a thirteenth aspect, in the apparatus of the seventh or eighth aspect, when the layer control unit causes transition to a marker mode included in the plurality of modes in the third layer, the gesture recognition unit recognizes a gesture operation for displaying a marker line on a display.

According to a fourteenth aspect, the apparatus of the thirteenth aspect includes a plurality of image capturing devices, a pointed position detection unit, and a display control unit. The plurality of image capturing devices capture a plurality of images of a display of the apparatus and a hand of a user. The hand of the user is the pointing object. The pointed position detection unit analyzes image data of the plurality of images captured by the plurality of image capturing devices, and detects a plurality of coordinates on the display pointed by a forefinger of the user. When the gesture recognition unit recognizes a gesture operation of pointing the forefinger at the display and moving a pen down in the marker mode, the gesture recognition unit identifies a pen-down mode. The pointed position detection unit detects the plurality of coordinates on the display pointed by the forefinger. The display control unit displays the marker line as a trajectory of the plurality of coordinates detected by the pointed position detection unit. When the gesture recognition unit recognizes a gesture operation of moving the pen up, the gesture recognition unit identifies a pen-up mode, and the display control unit stops drawing the marker line.

According to a fifteenth aspect, in the apparatus of the fourteenth aspect, the display control unit displays a marker icon at the plurality of coordinates detected by the pointed position detection unit in the marker mode.

According to a sixteenth aspect, in the apparatus of the fifteenth aspect, when the gesture recognition unit recognizes the gesture operation of pointing the forefinger at the display and moving the pen down in the marker mode, the gesture recognition unit identifies the pen-down mode, and the display control unit displays the marker icon in a style different from a style used in a mode previous to the pen-down mode.

According to a seventeenth aspect, in the apparatus of one of the seventh to sixteenth aspects, the plurality of modes in the third layer include a pen mode, a marker mode, and an eraser mode. The gesture recognition unit recognizes, from an identical gesture operation, a gesture operation for moving a pen down in the pen mode, a gesture operation for moving a pen down in the marker mode, and a gesture operation for bringing a virtual eraser into contact with a display of the apparatus in the eraser mode. The gesture recognition unit further recognizes, from another identical gesture operation, a gesture operation for moving the pen up in the pen mode, a gesture operation for moving the pen up in the marker mode, and a gesture operation for releasing the virtual eraser from the display in the eraser mode.

According to an eighteenth aspect, in the apparatus of one of the seventh to sixteenth aspects, the plurality of modes in the third layer include a pen mode, a marker mode, and an eraser mode. The gesture recognition unit recognizes, from an identical gesture operation, a gesture operation for ending the pen mode, a gesture operation for ending the marker mode, and a gesture operation for ending the eraser mode.

According to a nineteenth aspect, the apparatus of one of the seventh to sixteenth aspects includes a display control unit. The plurality of modes in the third layer include a pen mode, a marker mode, and an eraser mode. In the pen mode, the marker mode, or the eraser mode, the display control unit displays a menu button used in the pen mode, the marker mode, or the eraser mode, and hides a menu button unused in the pen mode, the marker mode, or the eraser mode.

1. An apparatus comprising circuitry configured to
acquire information related to a shape of a pointing object from a sensor that acquires the information, and
recognize a gesture operation based on the acquired information, the gesture operation corresponding to a motion of the pointing object and being recognizable in one of at least three layers in which a plurality of gesture operations are classified, wherein
when the circuitry recognizes a first gesture operation in a top layer of the at least three layers, the circuitry becomes ready to recognize a gesture operation classified in a second layer of the at least three layers, and
when the circuitry recognizes a second gesture operation in the second layer, the circuitry becomes ready to recognize a gesture operation classified in a third layer of the at least three layers.

2. The apparatus of claim 1, wherein when the circuitry recognizes, in the second layer, a gesture operation for ending the recognition of the gesture operation classified in the second layer, the circuitry becomes ready to recognize a gesture operation classified in the top layer, and
wherein when the circuitry recognizes, in the third layer, a gesture operation for ending the recognition of the gesture operation classified in the third layer, the circuitry becomes ready to recognize the gesture operation classified in the second layer.

3. The apparatus of claim 1, wherein the circuitry causes transition from a current layer to an upper layer or a lower layer in the at least three layers.

4. The apparatus of claim 1, wherein when the circuitry recognizes the pointing object in an initial state, the circuitry identifies the top layer and becomes ready to recognize a gesture operation classified in the top layer.

5. The apparatus of claim 4, wherein the second layer includes a plurality of modes for using a plurality of particular features of the apparatus, and
wherein when the circuitry recognizes the first gesture operation in the top layer, the circuitry causes transition to the second layer and to a mode of the plurality of modes in the second layer, the mode in the second layer being associated with the recognized first gesture operation.

6. The apparatus of claim 5, further comprising:
a display including a touch panel to display a drawn line input in handwriting on the touch panel with a pen or finger; and
a plurality of image capturing devices to capture a plurality of images of the display of the apparatus and a hand of a user, the hand of the user being the pointing object,
wherein when the circuitry recognizes, in the top layer, the first gesture operation to transition to a pointer mode included in the plurality of modes in the second layer, the circuitry
causes transition from the top layer to the pointer mode in the second layer,
analyzes image data of the plurality of images captured by the plurality of image capturing devices,
detects a plurality of coordinates on the display pointed by a forefinger of the user, and
displays a pointer at the detected plurality of coordinates on the display.

7. The apparatus of claim 4, wherein the third layer includes a plurality of modes for using a plurality of particular features of the apparatus, and
wherein when the circuitry recognizes the second gesture operation in the second layer, the circuitry causes transition to the third layer and to a mode of the plurality of modes in the third layer, the mode in the third layer being associated with the recognized second gesture operation.

8. The apparatus of claim 7, wherein the second layer includes a plurality of modes for using a plurality of particular features of the apparatus, each mode of the plurality of modes in the second layer being associated with one or more second gesture operations recognizable by the circuitry, and
wherein when the circuitry recognizes, in a mode of the plurality of modes in the second layer, a second gesture operation associated with the mode, the circuitry causes transition to the third layer and to the mode of the plurality of modes in the third layer, the mode in the third layer associated with the recognized second gesture operation.

9. The apparatus of claim 7, wherein when the circuitry causes transition to a pen mode included in the plurality of modes in the third layer, the circuitry recognizes a gesture operation for displaying a drawn line on a display.

10. The apparatus of claim 9, further comprising:
the display; and
a plurality of image capturing devices to capture a plurality of images of the display and a hand of a user, the hand of the user being the pointing object,
wherein the circuitry
analyzes image data of the plurality of images captured by the plurality of image capturing devices,
detects a plurality of coordinates on the display pointed by a forefinger of the user, and
displays the drawn line on the display as a trajectory of the detected plurality of coordinates,
wherein when the circuitry recognizes, based on the analyzed image data of the captured plurality of images, a gesture operation of pointing the forefinger at the display and moving a pen down in the pen mode, the circuitry identifies a pen-down mode, and
wherein when the circuitry recognizes, based on the analyzed image data of the captured plurality of images, a gesture operation of moving the pen up in the pen mode, the circuitry identifies a pen-up mode and stops drawing the drawn line.

11. The apparatus of claim 10, wherein the circuitry displays a pen icon at the detected plurality of coordinates in the pen mode.

12. The apparatus of claim 11, wherein when the circuitry recognizes, based on the analyzed image data of the captured plurality of images, the gesture operation of pointing the forefinger at the display and moving the pen down in the pen mode, the circuitry identifies the pen-down mode and displays the pen icon in a style different from a style used in a mode previous to the pen-down mode.

13. The apparatus of claim 7, wherein when the circuitry causes transition to a marker mode included in the plurality of modes in the third layer, the circuitry recognizes a gesture operation for displaying a marker line on a display.

14. The apparatus of claim 13, further comprising:
the display; and
a plurality of image capturing devices to capture a plurality of images of the display and a hand of a user, the hand of the user being the pointing object,
wherein the circuitry
analyzes image data of the plurality of images captured by the plurality of image capturing devices, and
detects a plurality of coordinates on the display pointed by a forefinger of the user,
wherein when the circuitry recognizes, based on the analyzed image data of the captured plurality of images, a gesture operation of pointing the forefinger at the display and moving a pen down in the marker mode, the circuitry identifies a pen-down mode, detects a plurality of coordinates on the display pointed by the forefinger, and displays the marker line as a trajectory of the detected plurality of coordinates, and
wherein when the circuitry recognizes, based on the analyzed image data of the captured plurality of images, a gesture operation of moving the pen up in the marker mode, the circuitry identifies a pen-up mode and stops drawing the marker line.

15. The apparatus of claim 14, wherein the circuitry displays a marker icon at the detected plurality of coordinates in the marker mode.

16. The apparatus of claim 15, wherein when the circuitry recognizes, based on the analyzed image data of the captured plurality of images, the gesture operation of pointing the forefinger at the display and moving the pen down in the marker mode, the circuitry identifies the pen-down mode and displays the marker icon in a style different from a style used in a mode previous to the pen-down mode.

17. The apparatus of claim 7, wherein the plurality of modes in the third layer include a pen mode, a marker mode, and an eraser mode,
wherein the circuitry recognizes, from an identical gesture operation, a gesture operation for moving a pen down in the pen mode, a gesture operation for moving a pen down in the marker mode, and a gesture operation for bringing a virtual eraser into contact with a display of the apparatus in the eraser mode, and
wherein the circuitry recognizes, from another identical gesture operation, a gesture operation for moving the pen up in the pen mode, a gesture operation for moving the pen up in the marker mode, and a gesture operation for releasing the virtual eraser from the display in the eraser mode.

18. A display system comprising:
an apparatus to recognize a gesture operation corresponding to a motion of a pointing object and receive an operation according to the gesture operation; and
an information processing system to communicate with the apparatus via a network,
the apparatus including
first circuitry configured to acquire information related to a shape of the pointing object from a sensor that acquires the information, and
a first network interface circuit to transmit the information to the information processing system, and
the information processing system including
second circuitry configured to analyze the information received from the apparatus and recognize the gesture operation based on the information acquired by the sensor, the gesture operation being recognizable in one of at least three layers in which a plurality of gesture operations are classified, and
a second network interface circuit to report to the apparatus a layer of the at least three layers corresponding to the recognized gesture operation, wherein
when the second circuitry of the information processing system recognizes a first gesture operation in a top layer of the at least three layers, the second circuitry of the information processing system becomes ready to recognize a gesture operation classified in a second layer of the at least three layers,
when the second circuitry of the information processing system recognizes a second gesture operation in the second layer, the second circuitry of the information processing system becomes ready to recognize a gesture operation classified in a third layer of the at least three layers, and
the first circuitry of the apparatus executes a process in the layer reported from the information processing system.

19. A gesture recognition method comprising:
acquiring information related to a shape of a pointing object from a sensor; and
recognizing a gesture operation based on the acquired information, the gesture operation corresponding to a motion of the pointing object and being recognizable in one of at least three layers in which a plurality of gesture operations are classified,
wherein, when the recognizing recognizes a first gesture operation in a top layer of the at least three layers, the method further comprises:
becoming ready to recognize a gesture operation classified in a second layer of the at least three layers, and
wherein, when the recognizing recognizes a second gesture operation in the second layer, the method further comprises:
becoming ready to recognize a gesture operation classified in a third layer of the at least three layers.

20. A non-transitory recording medium storing a plurality of instructions which, when executed by one or more processors, causes the one or more processors to perform the method according to claim 19.
